(19) United States
(12) Patent Application Publication
(10) Pub. No.: US 2014/0326643 A1
(43) Pub. Date: Nov. 6, 2014

(54) FLOTATION MACHINE, FROTH RECOVERY APPARATUS, AND METHOD FOR RECOVERING MATERIAL

(71) Applicants: Timothy J. Olson, Draper, UT (US); Ronney Rogerio Rodrigues Silva, Sandy, UT (US)

(72) Inventors: Timothy J. Olson, Draper, UT (US); Ronney Rogerio Rodrigues Silva, Sandy, UT (US)

(73) Assignee: FLSmidth A/S, Valby (DK)

(21) Appl. No.: 13/996,741

(22) PCT Filed: Dec. 21, 2011
(86) PCT No.: PCT/US11/66391

§ 371 Date: Oct. 17, 2013

Related U.S. Application Data
(60) Provisional application No. 61/425,296, filed on Dec. 21, 2010.

(51) Int. Cl. B03D 1/14; B03D 1/02

(52) U.S. Cl. CPC B03D 1/1406; B03D 1/02; B03D 2201/04
USPC 209/12.1; 209/168; 209/166

(57) ABSTRACT

At least one froth receiving device may be positioned in a slurry retained in a tank of a flotation cell of a flotation machine. Each of the froth receiving devices may be positioned adjacent to froth formed in the slurry by being positioned in the tank at a height that positions the froth receiving device in the froth or near the froth. Each froth receiving device may receive froth to extract the froth from the tank. In some embodiments, the extracted froth may be sent to at least one particle separation device so at least a portion of solid material in the froth is separated from liquid of the froth. The separated solid material may be moved to another machine for further processing for recovering the desirable material while any remaining solid material and liquid may be sent to another device for being utilized in further material processing.

### CROSS REFERENCE TO RELATED APPLICATIONS

The present application claims priority to U.S. Provisional Patent Application No. 61/425,296, which was filed on Dec. 21, 2010. The entirety of U.S. Provisional Patent Application No. 61/425,296 is hereby incorporated by reference herein.

### FIELD OF INVENTION

The present invention relates to devices and methods used to recover solids that are suspended in the froth that may be formed in a slurry, or pulp, retained in flotation machines. One example of a flotation machine is a flotation machine that utilizes one or more flotation cells that have tanks that retain a slurry, or pulp, to recover particles of material such as ore, minerals, metal, or other material that is within solid material suspended in a liquid of the slurry, or pulp.

### BACKGROUND OF THE INVENTION

Flotation machines often include a tank that retains a slurry, or pulp. Examples of such machines may be appreciated from U.S. Pat. Nos. 4,425,232, 4,800,017, and 5,205,926. The entirety of U.S. Pat. Nos. 4,425,232, 4,800,017, and 5,205,926 are incorporated by reference herein. The slurry retained by such tanks may include solid material such as ore or minerals that is mixed in a liquid such as water. For example, the material present in the slurry may include particles of copper bearing minerals, coal, iron minerals, phosphate rock, potash, silica, base metal sulfide or precious metal.

The slurry retained in the tank may be aerated to generate froth to suspend solid particles in the froth. The froth may be a large amount of bubbles formed at the top of the slurry in the tank. For instance, froth may be generated via a forced air technology to create bubbles and generate the froth. Alternatively, bubbles may be generated via a self-aspirated technology to create the froth. The tanks are designed so that the froth, which contains the solid particles, may be passed into one or more launders adjacent to the tank to separate the valuable minerals from the other liquid and other material. It should be understood that after the material is sent to the one or more launders, it may be further processed to recover the desired material.

The flotation machines are typically designed so that the froth that is generated is able to remove particles of solids from within the froth to one or more launders to recover the minerals or other valuable portions of the solid material suspended within the bubbles. Such recovery of materials, however, often only recovers very fine particles. Solids that are relatively coarse, such as material that is between 100 micrometers and 210 micrometers in size or material that is larger than 210 micrometers in size may not be recovered via the flotation machines because the coarse material may fall out of suspension when in the froth due to the size and weight of the coarser particles and due to the bubble coarsening due to coalescence. For instance, studies have shown that as low as 5-10% of the coarser sized particles that have been captured and suspended in froth are eventually recovered in the product launder.

A device is needed that may help a flotation machine improve its recovery of relatively fine particles of material so that coarser fine materials may be recovered by the flotation machines to improve the recovery rate of desirable material from the slurry. Preferably, the device is able to be provided as either an add-on mechanism that can be retrofitted to existing flotation machines or may be provided as a part of a new flotation machine.

### SUMMARY OF THE INVENTION

A flotation machine may include at least one flotation cell. Each flotation cell may include a tank sized to retain a slurry that includes a liquid mixed with at least one solid material. The machine may also include at least one froth receiving device that is sized and configured to be positioned in the tank adjacent the slurry retained in the tank and in or adjacent a froth formed on the slurry. The at least one froth receiving device receives the froth so that the received froth is moveable out of the tank via the froth receiving device.

It should be understood that the liquid of the slurry may be an untreated liquid in some embodiments. The at least one solid material of the slurry may be a plurality of particulates of solid material that are mixed with the liquid. The particulates may range in size from very fine material to middling sized material to material that is much coarser. For example, particulates may range in size from under twenty-five micrometers to over four hundred micrometers. Of course, other size ranges of particulates may be present in different embodiments.

A froth recovery apparatus is also provided. The apparatus includes a froth receiving body that has at least one aperture for receiving the froth of a flotation machine cell or flotation column cell. The froth receiving body is sized and configured to be positioned in the tank adjacent the slurry and in or adjacent the froth to receive the froth. At least one conduit is connected to the froth receiving body so that the froth received in the at least one aperture is moveable out of the flotation column cell or flotation machine cell.

A flotation machine is also provided that includes one or more flotation cells, one or more froth receiving devices, and one or more particle separation devices. The one or more froth receiving devices are positionable in slurry retained in the tank of the one or more flotation cells. The one or more froth receiving devices receive froth formed in the slurry and move the froth to the one or more particle separation devices. The one or more particle separation devices separate a portion of at least one solid material in the froth from liquid in the froth. For example, particulates of the at least one solid material over a certain size may be separated from the liquid. That material may then be transported to another element for further material processing. The liquid and remaining solid material may then be recycled to another flotation cell or may be sent to another material processing element for further processing of the slurry.

Some embodiments of the flotation machine may utilize one or more pumps connected to the one or more froth receiving devices to provide pressure for moving the forth received by the at least one froth receiving device to the at least one particle separation device. A conduit may be connected between the at least one froth receiving device and at least one particle separation device. The conduit may also be connected to the one or more pumps. Preferably, the conduit is comprised of at least one pipe or tube.

The froth receiving device may include a froth receiving body that is sized and configured to receive the froth. The froth receiving body may have an aperture that is in communication with a channel of the conduit so that the froth is moveable from the froth receiving body, through the conduit, and to the at least one particle separation device. The one or more particle separation devices may include a circuit of cyclones, a circuit of hydrocyclones, one or more hydrocyclones or one or more cyclones. Preferably, the particle separation device is configured to classify the froth by mass or weight so that liquid is separatable from at least a portion of the solid material in the received froth. For instance, liquid and particulates of the solid material that are under a predetermined size range may be separated from coarser particulates of the solid material. The predetermined size range may define a fine solids size range.

Embodiments of the flotation machine may also include one or more depth adjustment mechanisms connected to the one or more froth receiving devices so the one or more froth receiving devices are moveable within the slurry to adjust a position of the one or more froth receiving devices in the slurry. The one or more depth adjustment mechanisms may include elongated members such as chains, cables, cords, rope, piping or telescoping tubes or pipes that move to extend or retract the elongated members to adjust the depth of the one or more froth receiving devices. An actuation mechanism may be provided for winding and unwinding the elongated members to adjust the depth of the one or more froth receiving devices. As an alternative embodiment, a diaphragm may be provided in one or more floatable bodies that are adjustable to adjust the depth of the one or more froth receiving devices.

One or more spray mechanisms may also be included in embodiments of the froth receiving device. A spray mechanism may be configured to spray a liquid, such as water, salt water, or a solution, onto froth received by the one or more froth receiving devices so that the liquid and the froth is transportable to the at least one particle separation device.

A froth recovery apparatus is also provided. The froth recovery apparatus may be configured to receive froth in a flotation machine. The froth may be formed in a slurry retained by the flotation machine that includes liquid and solid material. Embodiments of the froth recovery apparatus may include embodiments of the above referenced froth receiving device. As another example, embodiments of the froth recovery apparatus may include a froth receiving body that has one or more apertures for receiving the froth of the flotation machine and a conduit for connecting the froth receiving body to a launder and/or a particle separation device so that the froth is moveable to the launder and/or particle separation device.

Embodiments of the froth recovery apparatus may include one or more floatable bodies configured to float in the slurry that are connected to the froth receiving body. Embodiments may also include one or more pumps connected to the conduit. The one or more pumps may provide pressure to facilitate movement of the froth to the launder and/or particle separation device.

Embodiments of the froth recovery apparatus may also include one or more depth adjustment mechanisms or one or more spray mechanisms. The one or more sprayer mechanisms may include one or more sprayers positioned adjacent to or within the froth receiving body to spray a liquid at the froth received by the froth receiving body.

Some embodiments of the froth recovery apparatus may be configured so that the froth receiving body includes a frame that is connected to one or more floatable bodies and a plurality of projection members attached o the frame. The one or more apertures of the froth receiving body may be channels defined in respective ones of the projection members. The froth receiving body may also include a froth collection body that has a cavity that is in communication with the channels to receive froth from the channels before the froth is moved to the launder and/or particle separation device. The froth collection body may be positioned above or below the froth receiving inlet portions of the channels.

In yet other embodiments of the froth receiving apparatus, the froth receiving body may include a froth retaining member that is connected to at least one floatable body and a plurality of froth receiving conduits. The one or more apertures may be one or more channels defined by the froth retaining member. A mouth of each of the froth receiving conduits is positioned adjacent to the one or more channels to receive froth captured within the at least one channel. The froth retaining member may be configured as a top launder in some embodiments of the froth receiving apparatus.

A kit for retrofitting a flotation machine is also provided. The kit may include embodiments of the above referenced froth recovery apparatus and may also include one or more particle separation devices or other components.

A method for recovering material from a flotation machine is also provided. The method includes creating froth in a tank of a flotation cell, positioning one or more froth receiving devices in the slurry retained by the flotation cell adjacent to the froth, receiving the froth by the one or more froth receiving devices, and moving the received froth to a launder and/or a particle separation device.

In some embodiments of the method, solid material in the received froth may be separated from the liquid of the froth by one or more particle separation devices. The one or more solid material may be solids composed of a mineral, a metal, copper, iron, coal, or a base metal.

A pump may be utilized to generate pressure for moving the froth to the particle separation device and/or the launder. The depth of the one or more froth receiving devices may be adjusted or the one or more froth receiving devices may be moved to adjust a position of the at least one froth receiving device.

A flotation machine is also provided that includes a first flotation cell, a launder positioned adjacent to the tank of the first flotation cell, and at least one froth receiving device. The one or more froth receiving devices receive the froth that is formed in the tank and move the froth toward the launder via a conduit connecting the froth receiving device to the launder.

A particle separation device may be positioned adjacent to the launder so that the conduit is connected between the particle separation device and the one or more froth receiving devices. The at least one particle separation device may separate the liquid of the froth from a portion of the solid material in the froth. The separated liquid may be passed back into the tank. The solid material that is separated may be fed to the launder.

Embodiments of the flotation machine may also include additional flotation cells, launders positioned adjacent to the flotation cells and other froth receiving devices. For example, some embodiments of the flotation machine may include a second flotation cell, a second launder positioned adjacent to the tank of the second flotation cell, and at least one second froth receiving device. The one or more second froth receiving device may receive froth from the tank of the second flotation cell and move the froth to the second launder via a second conduit connecting the one or more second froth receiving devices to the launder. One or more second particle separation devices may be positioned adjacent to the second launder and the received froth may be moved to the one or more second particle separation devices so that the one or more second particle separation devices separate the liquid of the froth from a portion of the one or more solids within the froth. Preferably, the at least one particle separation device and at least one second particle separation device are each configured to separation a portion of the solids in the froth that is larger than 10-50 micrometers from the liquid of the froth.

Other details, objects, and advantages of the invention will become apparent as the following description of certain present preferred embodiments thereof and certain present preferred methods of practicing the same proceeds.

### BRIEF DESCRIPTION OF THE DRAWINGS

Present preferred embodiments of flotation machines that utilize embodiments of a froth receiving device, embodiments of the froth receiving device and methods of making and using the same are shown in the accompanying drawings. It should be understood that like reference numbers used in the drawings may identify like components.

FIG. 1 is a top plan view of a first exemplary embodiment of a flotation machine.

FIG. 1A is a top view of an exemplary embodiment of a froth receiving device utilized in embodiments of the flotation apparatus.

FIG. 2 is a cross sectional view of a flotation cell 2 of the first exemplary embodiment of the flotation machine taken along line II-II in FIG. 1.

FIG. 3 is a top plan view of a second exemplary embodiment of the flotation machine that utilizes a plurality of nested flotation cells.

FIG. 4 is a perspective view of a first exemplary embodiment of a froth receiving device that may be utilized in embodiments of a flotation machine.

FIG. 5 is a perspective view of a second exemplary embodiment of a froth receiving device that may be utilized in embodiments of a flotation machine.

FIG. 6 is a fragmentary view illustrating a froth inlet portion of a channel in the second exemplary embodiment of the froth receiving device.

FIG. 7 is a perspective view of a third exemplary embodiment of a froth receiving device that may be utilized in embodiments of a flotation machine.

FIG. 8 is a perspective view of a fourth exemplary embodiment of a froth receiving device that may be utilized in embodiments of a flotation machine.

FIG. 9 is a cross sectional view of a fifth exemplary embodiment of a froth receiving device that may be utilized in embodiments of a flotation machine.

FIG. 10 is a perspective view o a sixth exemplary embodiment of a froth receiving device that may be utilized in embodiments of a flotation machine.

FIG. 10A is cross sectional view of a seventh exemplary embodiment of a froth receiving device that may be utilized in embodiments of a flotation machine.

FIG. 11 is a chart illustrating the copper recovered by different flotation cells used in a first test that was conducted to determine whether the use of embodiments of the froth receiving device could provide a significant improvement in recovery of material by a flotation machine.

FIG. 12 is a chart illustrating the molybdenum recovered by different flotation cells used in a second test that was conducted to determine whether the use of embodiments of the froth receiving device in connection with particle separation device, such as a hydrocyclone, could provide a significant improvement in recovery of material by a flotation machine.

FIG. 13 is a graph illustrating results of the molybdenum recovery determined from the second test as a function of size fraction.

FIG. 14 is a chart illustrating the recovery of molybdenum by size fraction that was measured as occurring in the second test for particles sized under 37 micrometers and particles sized between 37 micrometers and 150 micrometers.

FIG. 15 is a chart illustrating the recovery of molybdenum by size fraction measured to occur in the second test for particles sized between 150 micrometers and 210 micrometers and particles sized over 210 micrometers.

FIG. 16 is a graph illustrating a grade recovery relationship for a set of conducted tests.

FIG. 17 is a perspective view of an eighth exemplary embodiment of a froth receiving device that may be utilized in embodiments of a flotation machine.

FIG. 18 is a perspective view of a ninth exemplary embodiment of a froth receiving device that may be utilized in embodiments of a flotation machine.

FIG. 19 is a perspective view of a tenth exemplary embodiment of a froth receiving device that may be utilized in embodiments of a flotation machine.

FIG. 20 is a side view of an eleventh exemplary embodiment of a froth receiving device that may be utilized in embodiments of a flotation machine.

FIG. 21 is a perspective view of a twelfth exemplary embodiment of a froth receiving device that may be utilized in embodiments of a flotation machine.

FIG. 22 is a schematic drawing illustrating a present preferred apparatus used to extract froth from a flotation cell utilizing a froth receiving device.

FIG. 23 is a fragmentary perspective view of a present preferred apparatus used to extract froth from a flotation cell utilizing a froth receiving device.

### DETAILED DESCRIPTION OF PRESENT PREFERRED EMBODIMENTS

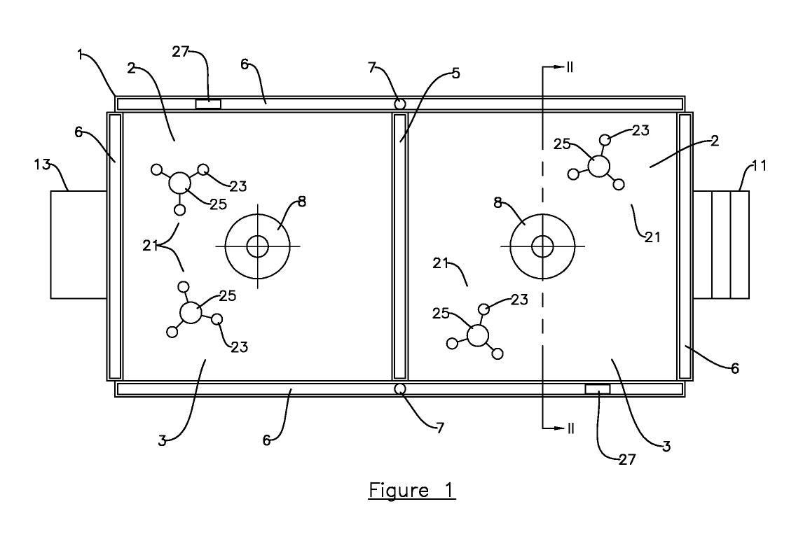

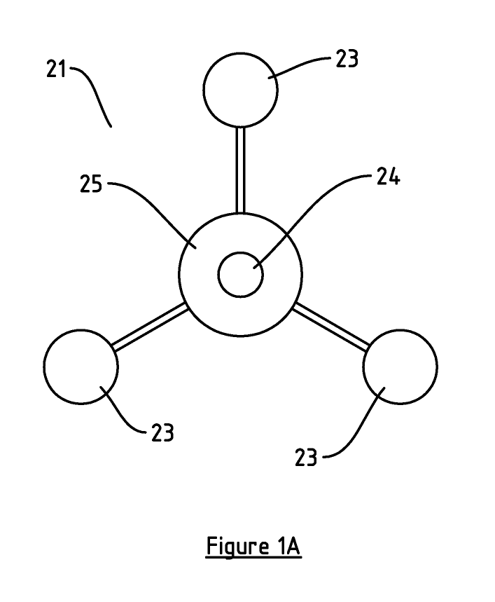

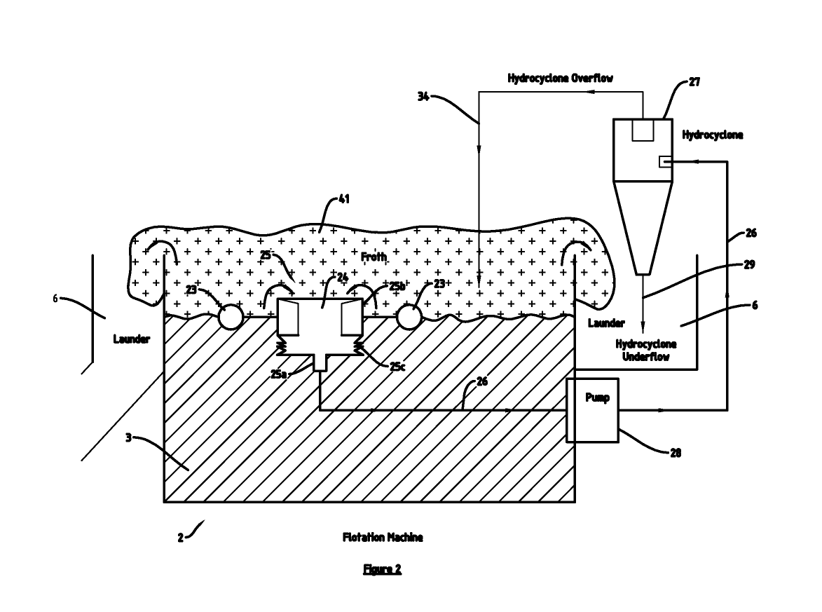

Referring to FIGS. 1, 1A and 2, a flotation machine 1 used to recover minerals from a slurry has a plurality of flotation cells 2. The number of flotation cells used in embodiments of the flotation machine 1 may range from one cell to a large number of cells. The number of cells needed for any particular flotation machine may be dependent on design requirements for the mineral or material recovery that the flotation machine is designed to meet. In some embodiments, the flotation machine may be a flotation column.

Each flotation cell 2 has a tank that retains slurry, which may also be referred to as pulp, within the tank 3. The tank 3 may have any of a number of different shapes. For example, each tank 3 may be shaped similarly to a large rectangular tank or may be a generally cylindrical tank as may be appreciated from U.S. Pat. No. 5,205,926 (the entirety of which is incorporated by reference herein).

A feed box 13 may be adjacent to one or more of the flotation cells 2 and may be where material is mixed with liquid to form the slurry, or pulp, that is subsequently fed into the tanks 3 of the cells 2. The liquid may be water, salt water, or a solution. The material that is mixed with the liquid may include rock, stone or dirt that includes one or more minerals or metals that are desired to be recovered from the material.

A plurality of launders 6 may be positioned around at least some of the sides of the tank 3 to receive froth that may flow over the sides of the tank. The froth may be generated by a rotation mechanism, forced air aeration mechanism, sparger, or other aeration mechanism 8 that is utilized to aerate the slurry to generate bubbles for forming the froth.

The launders 6 may have discharge outlets 7 for discharging froth received by the launders. The discharged froth may then be processed to separate the fine particles of the material that is within the froth to extract, or recover, desirable portions of this material, such as metal, a mineral, or other desirable material. A cross launder 5 may be positioned between the adjacent flotation cells 2 to divide the cells 2.

Unseparated solids and liquid of the slurry may be discharged via a discharge box 11 after the flotation machine has processed the slurry for a desired residence time. As will be understood by those of at least ordinary skill in the art, the residence time may be selected based on any of a number of design criteria. For instance, the residence time may be selected to provide a maximum amount of recovery of fine material or to provide a cost-effective or economically viable recovery of such material.

One or more froth receiving devices 21 may be positioned in each tank 3 of each flotation cell 2. The froth receiving device may be a froth recovery apparatus or may be a portion of a froth recovery apparatus. In embodiments using two or more froth receiving devices 21, each such froth receiving device 21 may be positioned at the same depth or a differing depth in the froth or in the slurry below the froth. The depths at which each froth receiving device 21 is positioned may also be adjusted via use of an adjustment mechanism or actuation of a depth adjustment mechanism of the froth receiving device 21. Depth adjustment may occur during operations to adjust the recovery rate of material.

The froth receiving devices 21 may include one or more floats 23 or other types of flotation mechanisms, floatable bodies, or positioning mechanisms for positioning the froth receiving mechanism 25 adjacent to the top of the slurry and the froth generated within each tank 2. The froth receiving mechanism 25 may include a froth receiving body that has an aperture 24 that is sized to receive froth and the solid particles that may be suspended in the froth. The aperture 24 may be defined in the froth receiving body such that the inlet, or mouth, of the aperture's height is adjustable. For example the froth receiving body may have one or more moveable portions that are moveable to move the location, depth or height of the inlet for the aperture 24. An actuation device may be attached to the at least one moveable portions of the froth receiving body to effect a movement of any such portion for adjusting the height of the aperture inlet. Such adjustment of the inlet for the aperture may adjust the effective depth of the aperture 24 relative to the froth and slurry to adjust the rate at which froth may be received by the aperture 24. Such a change in aperture inlet height may provide an effective depth adjustment of the froth receiving device 21.

One or more particle separation devices 27 may be positioned adjacent to each tank 3 to receive material from the froth receiving mechanism 25. An example of a particle separation device is a cyclone or a hydrocyclone. It should be appreciated that a particle separation device may also be other types of devices that may separate solid particles of at least a certain size from the liquid of the froth. Each particle separation device 27 may be positioned adjacent to a launder 6, may be positioned directly adjacent the flotation cell to receive froth from the tank, or may be positioned to receive froth via intermediary conduit and processing elements.

For instance, hydrocyclones may be positioned adjacent a tank to receive the froth directly from the tank or may alternatively be positioned remotely from the tank and receive froth from conduits and other intermediate froth processing elements. It should be understood that a particle separation device may of course include other types of particle separation devices instead of a hydrocyclone such as other devices configured to separate solid particulates from a liquid in which the solid particulates are mixed. For example, it is contemplated that a screen may be used to collect particulate material from the liquid of the froth so that the received froth is passed through the screen to separate particulates at or over a particular predefined size range from the slurry and smaller particulates in the slurry. The material collected on the screen may then be removed from the screen for further processing.

The particle separation devices may be configured to remove the liquid from the froth and recycle that liquid to the tank 3. Of course, some solid particles present in the froth may also be recycled to the tank 3. In some embodiments, the majority, if not all, of the solid particles of material within the froth may be separated and fed into a launder or other mechanism for further processing used to recover at least one desirable material from the solid particles.

It should be appreciated that the froth received by the froth receiving device may not be directly transported to a particle separation device and, in some embodiments, may never be sent to such a device. For example, the froth may be first sent to a regrind process, may be transported to a cleaner circuit bank of flotation cells, a feedbox, a de-sliming device, a sump, or a launder first. In yet other alternatives, the froth may simply be sent away from the tank in which it was collected as a finished product without particle separation.

As may be appreciated from FIG. 2, the froth receiving mechanism 25 of the froth receiving device 21 may include a froth receiving body that defines an aperture 24 for receiving froth. The aperture may be defined in an upper portion 25b of the froth receiving body. The froth receiving body 25b may be configured to float or may be configured to help support the lower portion of froth receiving body 25c and the outlet portion 25a of the froth receiving body when in the slurry adjacent to the froth 41 formed on the top of the slurry. The outlet 25a for the aperture 24 of the froth receiving body may be positioned in communication with the aperture 24 to feed froth to a particle separate device 27 via a conduit 26 attached to the outlet 25a. The conduit 26 may be attached to and in communication with one or more pumps 28 to generate the pressure, or suction, needed to pull froth into the aperture 24 of the froth receiving mechanism 25 and thereafter transport that froth to the particle separation device 27.

In alternative embodiments, the conduits may be arranged so that a pump or other equipment is not needed to help drive movement of the froth to a particle separation device or other material process element that may receive the froth collected by the froth receiving body. For example, conduits may be arranged to be downwardly inclined to receive the froth and move the froth such that gravity may be used to drive movement of the froth via conduits to a particle separation device or other material processing device. For example, conduits may be downwardly inclined tubing or piping that is used to transport froth collected by the froth receiving device to a particle separation device, a launder, or to a material processing mechanism such as a regrinding circuit of grinding machines or another flotation cell circuit of flotation machines.

In some embodiments, the particle separation device 27 may receive the froth and function to classify, or separate by mass, the solid particles of material in the froth that may contain a desired metal, mineral or other material for recovery from the liquid and very fine solid material in the froth. The very fine solid material that is not separated from the liquid may be, for example, solid particles that are equal to or less than ten micrometers in size or may be solid particles that are under twenty-five micrometers in size, under thirty-seven micrometers in size, under fifty micrometers in size, under sixty-five micrometers in size.

The separated liquid and very fine material may be fed back into the tank 3 via an overflow outlet 34. If the particle separation device is a hydrocyclone, the separated liquid and very fine material may be considered overflow and may experience a pressure drop sufficient to facilitate movement of the overflow for a predetermined distance. The predetermined distance may be, for example, equal to several feet or a couple of meters of hydrostatic head within the outlet 34 or other conduit connected to the outlet 34 for transporting the overflow. In alternative embodiments, the separated liquid and very fine material fed from the outlet 34 may be sent to other locations in a flotation machine or flotation circuit of the flotation machine such as a cleaner, a scavenger or a launder depending upon specific requirements for the flotation machine.

The solid particles separated from the liquid are output from the separation device 27 via an outlet flow 29. The outlet flow 29 of particles may be fed into a launder 6 for transport to a mechanism for further processing or may be fed to another device or mechanism to be further processed to recover the desired material from the particles. Such other device or mechanism may be, for example, a regrinding circuit of devices, a feedbox for introduction of material into another set of flotation cells or flotation machine for further processing, a de-sliming device, or a cleaner circuit. In yet other embodiments, the outlet flow 29 of particles may be sized and separated sufficiently for delivering as a finished product for transport to a customer for the customer to use as desired or to a storage location.

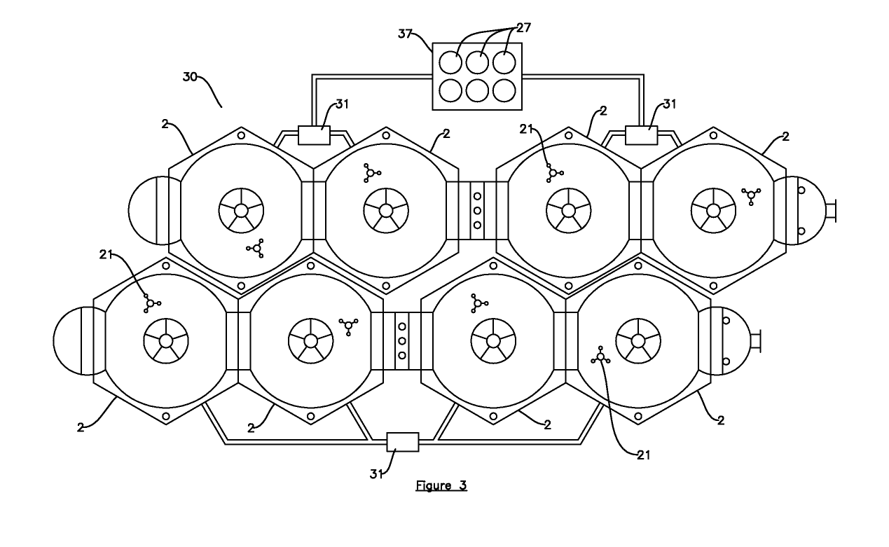

It should be understood that embodiments of the froth receiving device may be utilized in other types of flotation machines. For instance, a flotation machine that has a large number of nested cells may be configured to have one or more froth receiving devices 21 in each cell 2 of the flotation machine 30, as may be appreciated from FIG. 3. It should be appreciated that the flotation machine 30 may be a flotation column and that each cell may be a flotation column cell, for example. The nested cells may be arranged to include one type of floatation column cell or other cells in upstream cells for recovery of one type of particle size range and another type of set of flotation column cells or other types of cells downstream of those cells for recovery of another type of particle size range. For example, a flotation machine may include a number of cells that are Don-Oliver® unit cells to process finely sized particles and cells upstream or downstream of these cells may be WEMCO® or MixedRow™ cells for larger sized particle recovery such as middlings. Of course, it should be understood that other type of cells could be used as substitutes of the above referenced Dorr-Oliver®, WEMCO®, or MixedRow™ cells. In yet other embodiments, the cells may be arranged so that a number of different cells are located upstream and downstream of each other to provide a recovery of a number of different sized particles via froth generation and use of froth recovery devices in at least some, if not all, of these cells.

In one contemplated embodiment, the cells may be arranged so that the cells utilize different energy settings or different average bubble sizes. For example, such differing settings may be configured for the cells to provide downstream processing of middlings such that the more downstream the cell is located the lower the depth of the froth layer generated in that cell is where the middlings are located for collection. As another example, the energy settings or bubble sizes may be configured to permit upstream cells to position particles of a predetermined size in a different depth of the froth relative to downstream cells.

The froth receiving devices 21 of the flotation machine 30 may be configured similarly to the froth receiving devices 21 discussed above with reference to FIGS. 1-2, or may have other configurations utilized to receive froth, which includes solid particles suspended within that froth, and transport that froth to a particle separation device to help facilitate material recovery from the froth. For instance, one pump 31 may be connected to each of the froth receiving devices 21 and may be configured to provide sufficient pressure to permit the froth receiving devices to transport froth to a cyclone system 37 that may have a plurality of cyclones or hydrocyclones for separating particles of material from the liquid of the froth.

It should be appreciated that there are a number of different arrangements of flotation machines that may utilize one or more froth receiving devices 21. Systems utilizing one or more such flotation machines may be designed and used for recovering material. For instance, one or more flotation cells of one circuit of cells or one flotation machine may utilize froth receiving devices to transport froth received from those devices to a hydrocyclone or circuit of hydrocyclones. The liquid and fine particles in the upper flow outlet 34 of these one or more hydrocyclones may be transported to a flotation circuit or flotation machine that is configured for recovering finer particles. The outlet flow 29 may be transported to a flotation circuit or flotation machine configured to recover coarser particles or middlings. As another option, the fine material and liquid of the upper flow outlet 34 may be returned to a particular flotation cell of a flotation machine for further processing and the material obtained from the outlet flow 29 may simply be removed as recovered material or may be removed and subsequently sent for other processing used to extract a desired material from the particles, such as an ore or a mineral. As yet another example, the liquid and particulates from the upper flow outlet 34 may be sent to scavenger cells of a flotation machine so the fines can help stabilize a weak froth to recover more of the slow floating particles while the material of the outlet flow is removed as recovered material or transported to another mechanism used to extract a desired mineral or ore from the recovered particulates. Of course, in yet other systems of differing design, the froth captured by the froth receiving devices may be transported to a different type of particle separation device for removal of the liquid from the recovered froth to remove the liquid while the separated particles are sent to another mechanism for further material processing.

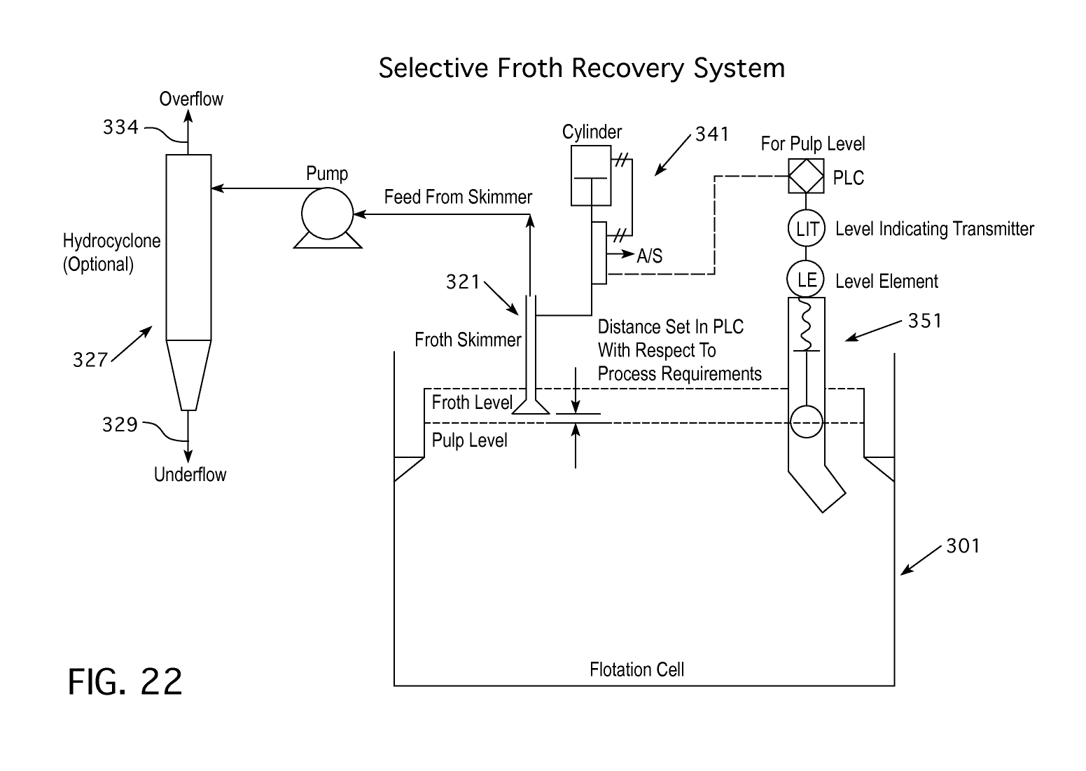

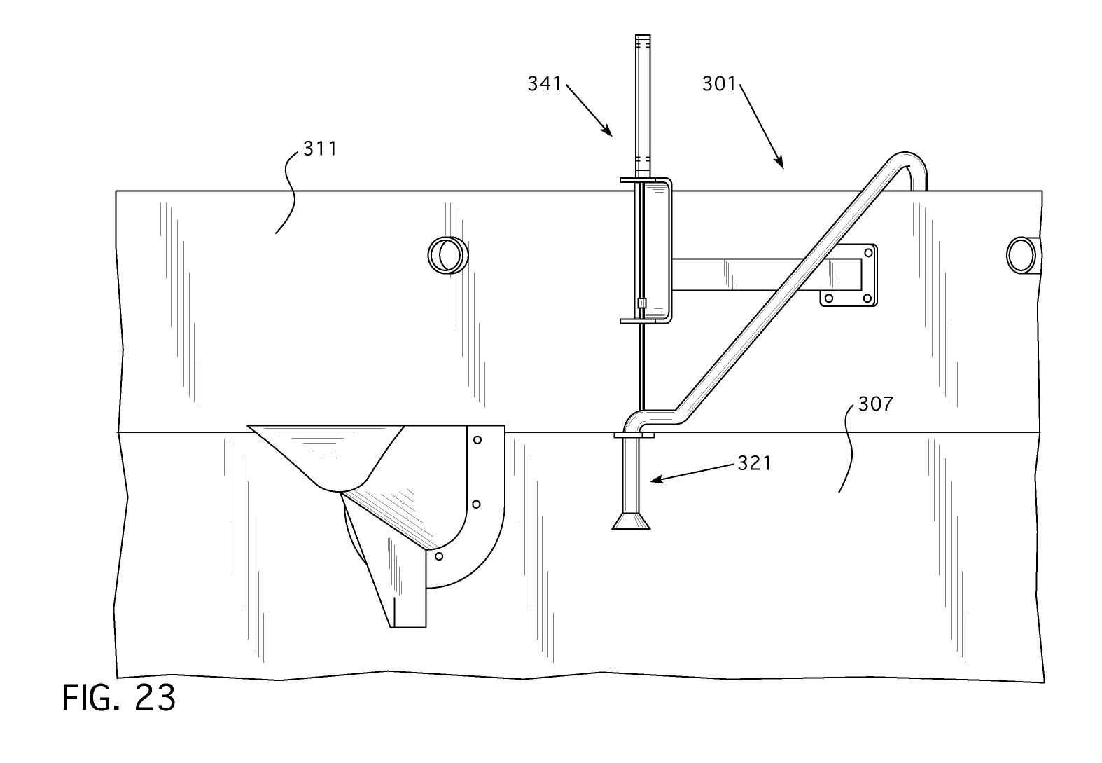

As yet another example of such a system, a flotation cell 301 may have one or more froth receiving devices 321 positioned in the tank 307 of the cell. The one or more froth receiving devices 321 may be adjustably positionable in the froth formed in the tank 307 of the flotation cell 301 as may be appreciated from FIGS. 22 and 23. The froth receiving device 321 may be attached to a portion of a launder 311 of the cell or alternatively a portion of a tank wall or other structure of the cell to position the froth receiving body in the tank of the cell to receive froth formed in the tank. The froth receiving devices may be configured to provide an inlet for receiving froth therein that is in communication with piping or other conduits that may provide a passageway for the froth received via the inlet to be transported to a particle separation device such as a hydrocyclone 327, which may separate the froth to separate liquid and finely sized particles in an overflow that passes through a first outlet 334 of the device and a flow of material passing through a second outlet 329 that is mostly coarser particles of material that was suspended within the received froth.

The depth of the froth receiving device 321 in the froth formed in the tank of the flotation cell may be set in a controller that is in communication with a hydraulic cylinder 341 that has a piston or other type of member connected to the froth receiving device 321 so that the depth of the froth receiving device 321 may be automatically controlled to maintain the relative position of the froth receiving device within the froth even when changes in pulp level, or slurry level, within the flotation cell may occur. The hydraulic cylinder may be moved to a retracted position to raise the position of the froth receiving device or may be moved to an extended position to lower the position of the froth receiving device 321. In alternative embodiments, it is contemplated that the hydraulic cylinder may be attached to the froth receiving device 321 so that a retraction of the cylinder lowers the depth of the froth receiving device 321 and an extension of the cylinder raises the depth of the froth receiving device in the froth.

A froth position detector or a pulp level detector 351 may be provided in the flotation cell 301. The detector 351 is configured to detect a position of the pulp level. The detector 351 may include a buoy or other floating element that floats on the top of the pulp to identify the height of the pulp level. A level element may be attached to the buoy and communicate to a transmitter that provides information to a controller PLC. The communicated information may communicate data that is correlated with the level or height at which the pulp is at or identifies the height at which the pulp, or slurry, is at and the bottom level of the froth in the tank of the flotation cell. If a change in the height of the pulp level is detected, the controller may provide a signal to the cylinder 341 via a wired connection or a wireless connection to actuate a retraction or extension of the cylinder to adjust the position of the froth receiving device 321 to account for the change in pulp level so that the froth receiving device is maintained at the same depth within the froth.

For example, if the pulp level drops by 0.2 meters and the froth level also drops by 0.2 meters, the controller PLC may detect such a change via the change in height communicated via the detector 351 and, as a result the PLC will actuate the cylinder 341 to adjust the position of the froth receiving body 321 so that the froth receiving body is also dropped in depth by two meters to account for the change in depth. It should be appreciated that the change in depth may be detected in a more periodic manner so that the change in depth is detected at different interval levels to actuate a corresponding change in depth of the froth receiving device 321. For instance, the controller PLC may be configured so that any change in pulp level of a predetermined distance, such as one centimeter, three centimeters, five centimeters, ten centimeters or thirty centimeters, or other predetermined distance range that results in the controller PLC actuating a movement of the cylinder 341 to adjust the depth of the froth receiving device to account for the detected change in depth.

It should be understood that the controller PLC may also be configured to permit a user to provide input to the controller PLC so that the depth of the froth receiving device 321 is changed to adjust a rate of froth recovery or to provide some other benefit as desired by the user. That change in depth may then be configured to be maintained for some period of time by the controller PLC by receipt of depth information obtained from the detector 351.

Further, the depth of the froth receiving device 321 may be correlated with the detected position of the buoy of the detector so that a determined position of the buoy is correlated with a position of the froth receiving device 321 that is for example, 0.2 meters higher than the buoy or some other predetermined difference in height. The controller PLC may then identify a position or depth of the froth receiving device based upon position information obtained via the detector 351.

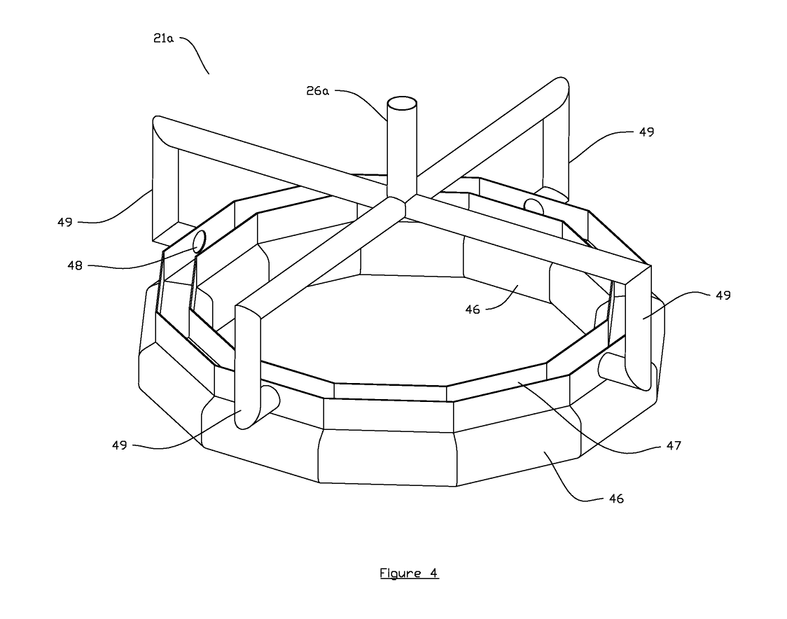

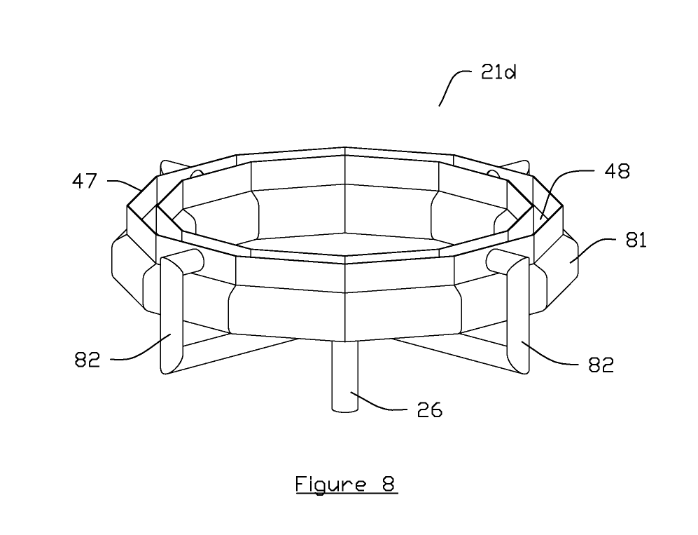

Alternative embodiments of the froth receiving device 21 and 321 may be appreciated from FIGS. 4-10A and 17-21. Of course, it should be appreciated that the froth receiving device may be structured to include yet other alternative designs as well. For instance, the embodiments of the froth receiving device 21 may be floating skimmers or floating launders that utilize pumped outlets.

Referring to FIG. 4, one alternative embodiment for the froth receiving device 21a may include a plurality of froth receiving conduits 49 connected to a conduit 26a for transporting the froth to the particle separation device 27. The conduit 26a may pass above one or more of the flotation cells to transport the froth to a particle separation device 27. Portions of the conduit 26a may be attached to a ceiling or supports adjacent to a ceiling of a facility to support the conduit 26a that passes over the flotation cells.

The froth receiving conduits 49 may each include an inlet opening that is positioned in or adjacent to a channel 48 defined in a retaining member 47 or defined by the retaining member 47. The retaining member 47 may be supported on the floatable body 46. The floatable body may be configured to float on top of the slurry within a tank 3.

The retaining member 47 may be configured to capture and retain froth for feeding the froth into the froth receiving conduits 49. For instance, the retaining member 47 may be an open top launder or may be structured to include two spaced apart walls connected to a floating body 46 to define the channel 48. The channel 48 may be formed in or defined by the retaining member so that the channel 48 is sized and configured to include multiple ramped or inclined surfaces to define bottommost portions in the channel 48 that are adjacent to the inlets of the froth receiving conduits 49. The inclined surfaces that extend away from and above these bottommost portions may define ramps that help direct froth retained by the retaining member 47 toward the inlets of the froth receiving conduits 49 to help facilitate the capture of froth material for transporting to one or more particle separation devices 27.

It should be appreciated that the froth receiving conduits 49 may include interconnected pipe segments, a welded pipe structure, or a tubular member that is formed to receive froth so that froth may be pulled or sucked into the receiving conduit 49 and transported to the conduit 26a. Embodiments of the froth receiving device may also be configured to have a dump valve to eliminate any plugging when the device is not in service.

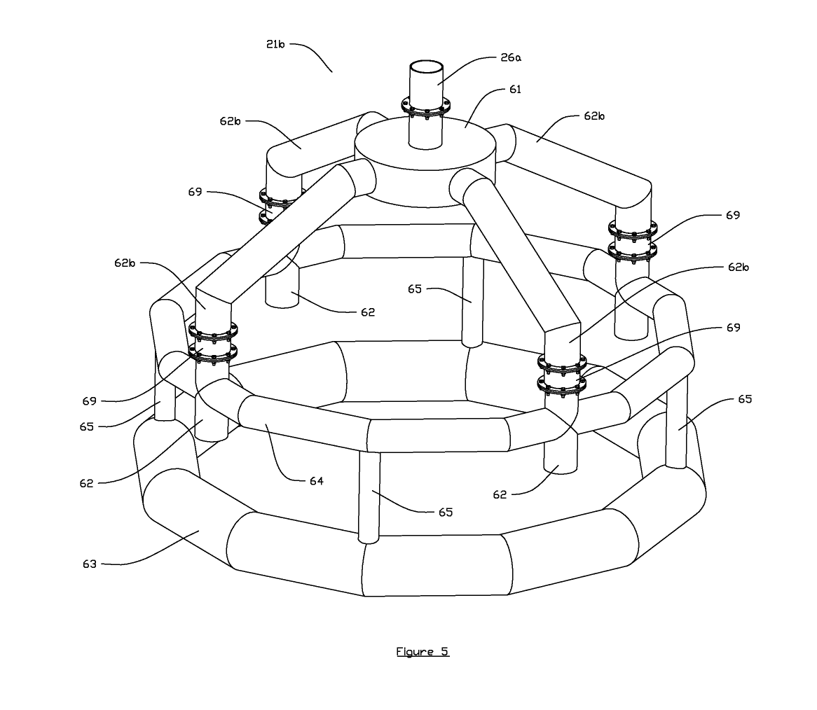

Another embodiment of the froth receiving device 21b, which is illustrated in FIG. 5, includes a frame 64 that is connected to a float or flotation body 63. The frame 64 may include projections or legs 65 that are welded, fastened, or otherwise connected to the flotation body 63 to support the frame 64 on the flotation body 63. The frame may include a plurality of projections or projection members 62 that define channels through which froth may pass. The projection members 62 may be sections of pipe or sections of tube that are connected to the frame 64. The channels of the projection members 62 each have a mouth 62a that is formed on an end of each member and is configured to be an inlet for receiving the froth.

Couplings 69 may connect froth transporting conduits 62b to a froth receiving body 61 that defines a cavity for receiving the froth from the different froth receiving projection members 62. The froth receiving body 61 is connected to a transport conduit 26a so that the cavity of the froth receiving body 61 is in communication with the conduit 26a, which permits the froth to be transported to a particle separate device 27 via pressure generated by a pump connected to the conduit 26a.

It should be appreciated that the couplings 69 may permit the froth transport conduits 62b and froth receiving body 61 to be easily disconnected from the frame 64 and subsequently reconnected to the frame 64 so that the frame 64 may be repaired or cleaned or so that the froth transporting conduits 62b may be cleaned or may be snaked or otherwise worked on to remove blockage or debris that may become stuck in the conduits and reduce the amount of froth received by the device 21b. Similarly, the projection members 62, or portions of the projection members 62 of the frame 64 may be more easily cleaned or snaked after the coupling is disconnected from the projection members 62.

In some embodiments of the froth receiving device 21b, the projection members 62 may include conduit connecting portions 62c that are configured to be connected to the froth transporting conduits 62b via the couplings 69. Alternatively, couplings 69 may not be used and the conduit connecting portions 62c may be attached or welded to the froth transporting conduits 62b. The conduit connecting portions 62c may be portions of the projection members 62 or may be separate components connected to the projection members 62.

Another embodiment of the froth receiving device 21c may include a frame that may be adjustably positioned at different depths of the slurry via a froth receiving device depth adjustment mechanism. The depth adjustment mechanism may include chains 71, cable, rope, or cords that are wound and unwound from spools or other collectors 102 above the flotation cell 2, as may be appreciated from FIG. 2.

In alternative embodiments, other elongated members that are moveable to raise or lower a frame 72 that is connected to projections 72b may be utilized. For example, a plurality of elongated telescoping members may also be connected to the floating body 63, a frame, or a portion of a froth retaining member to adjust the depth of the froth receiving device. The telescoping elongated members may be retracted to lower the depth of the froth receiving device and may be extended to do raise the depth of the froth receiving device.

Of course, the telescoping members may alternatively be positioned so that retraction raises the depth of the froth receiving device and extension lowers the depth of the froth receiving device. For example, extendable tubing may hang from an upper structure that is above the froth and help suspend the froth receiving device in the froth or otherwise adjacent the froth. The tubing may be moved upwardly or be retracted to raise the position of the froth receiving device and the tubing may be lowered or extended to lower the depth of the froth receiving device.

It is also contemplated that embodiments of the froth receiving device may have one or more floatable bodies that are configured to be adjustable to affect the depth at which the floatable bodies are positioned in the slurry. For example, each floating body may retain pressurized air and the pressure of the air contained within each floating body may be adjusted to adjust the buoyancy of the floating body and depth of the froth receiving device. For example, each floating body may have a diaphragm that is adjustable to adjust the pressure of the air contained in the diaphragm to adjust the buoyancy of the floating body and the depth of the froth receiving body.

Each projection 72b may be a protrusion, arm or leg that is attached to a frame member 72a. The projections 72b may be welded to the frame member 72a or may be otherwise attached, fastened, or affixed to the frame member 72a. Each projection 72b may define a channel for receiving and transporting froth.

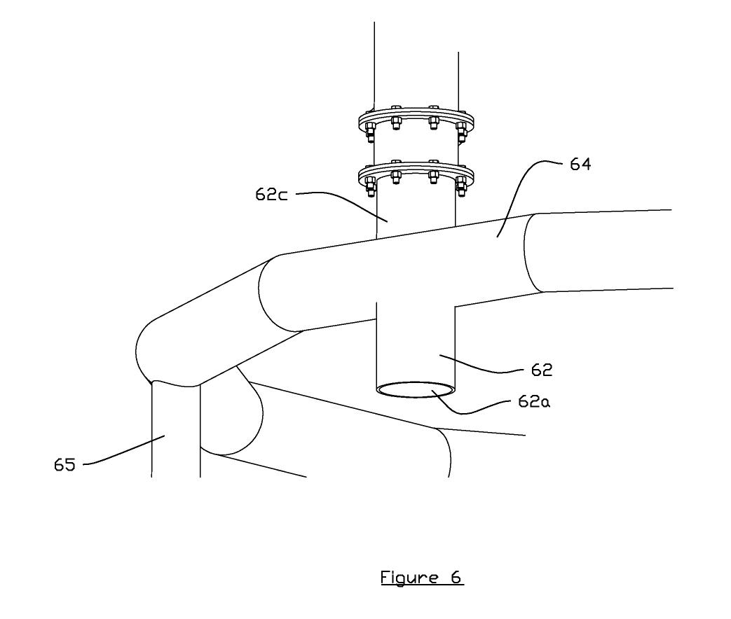

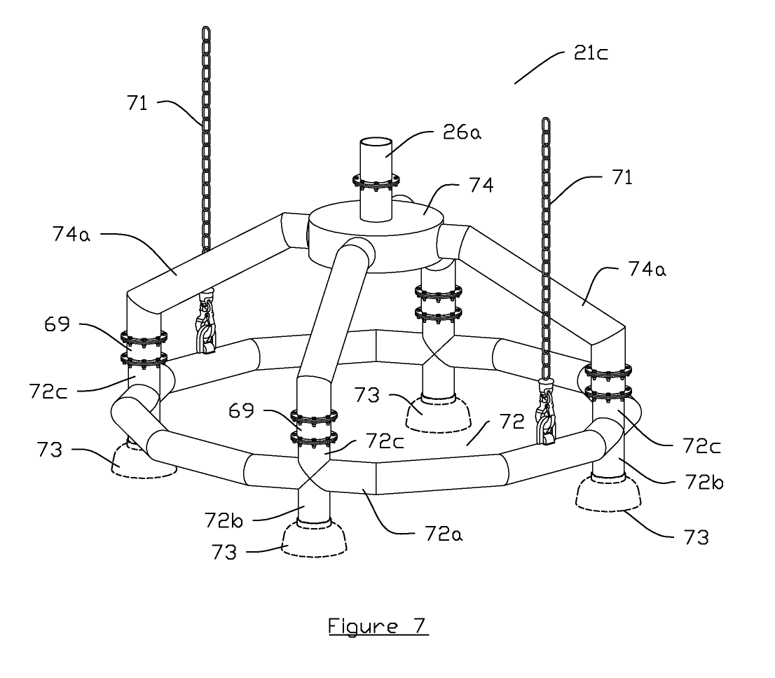

For some embodiments, an inlet for receiving froth may be defined by a mouth of the channel or may be defined by a wider froth receiving inlet member 73, which is shown in dotted line in FIG. 7. The froth receiving inlet member 73 may be a bell-shaped member that defines a mouth that is wider than the width or diameter of the channels of the projections 72b to enhance the froth receiving capacity of the projections 72b. It should be understood that the shape of the inlet mouth forming member, or froth receiving inlet member 73, may be any of a number of shapes or configurations and that embodiments of the froth receiving inlet member 73 may be utilized in connection with any of a number of different alternative embodiments, such as, for example, froth receiving device 21b shown in FIGS. 5 and 6.

Intermediate conduit portions 72c may be connected to the projections 72b such that channels defined in the intermediate conduits 72c are in communication with the channels of the projections 72b for receiving and further transporting froth pulled into the channels of the projections 72b.

A froth collection body 74 may be connected to a plurality of pipes, tubes or other conduits 74a that are connected to the projections 72b or intermediate conduits 72c to receive froth from the projections 72b. It should be appreciated that couplings 69 may be utilized to connect the froth collection body to the projections 69. The couplings may provide a releasable connection between the froth collection body 74 and the projections 72b or the frame 72. The froth collection body 74b may define a cavity that is in communication with the conduit 26 for transporting the froth to a particle separation device 27 via a pressure differential created by the one or more pumps 28 that are in communication with or otherwise connected to the conduit 26.

It should be understood that embodiments of the froth receiving device that are depth adjustable may have the depth of the devices adjusted to affect the recovery rate of material. For instance, depending on the particles of material being recovered, a lower depth or a higher depth may help a user maximize recovery of material or improve the grade of material being recovered by a flotation machine. For example, it is also contemplated that embodiments of the froth receiving device may be configured to receive an upper portion of the slurry that may have a relatively substantial amount of bubbles moving toward the froth for pulling the material suspended in the bubbles into the froth receiving conduits. Such a section of the slurry may be considered a lower portion of the froth.

It should be appreciated that embodiments of the froth receiving device may be configured to capture froth on its way towards the surface of the froth or the upper surface of the slurry within the tank. The capture of froth in this way may permit the froth to be collected without being substantially impacted by any loss in vertical velocity or horizontal transport issues such as plugging or other issues that may be detrimental to the flow of the froth.

Another contemplated alternative froth receiving device 21d includes a floating body 81 that is able to float on the top of the slurry within the froth. A froth retaining member 47 is connected to the floating body 81 so that the froth retaining member has walls that project above the floating body. Froth receiving conduits 82 that have mouths or inlets positioned in one or more walls of the froth retaining member to receive the froth or pull the froth into the froth receiving conduits 82 for sending the froth, which includes particles of material suspended therein, to a particle separation device 27 via a conduit 26. The conduit 26 may extend below the floatable body 81 to transport material through the flotation cell toward a particle separation device 27 or circuit 37 of particle separation devices.

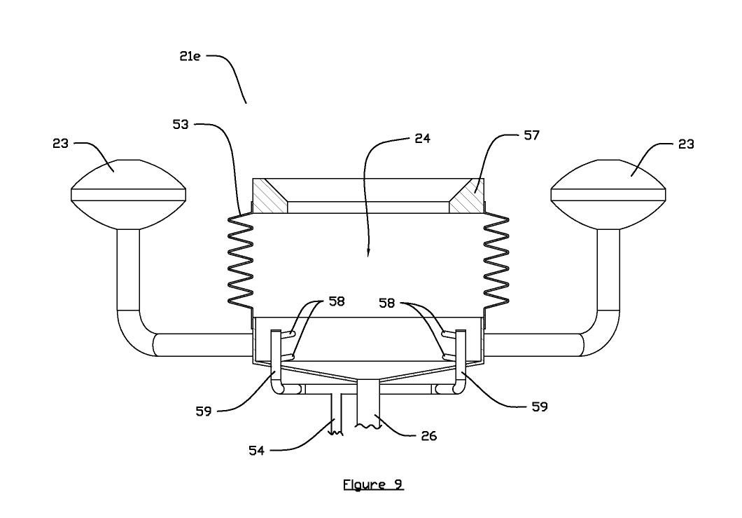

Yet another embodiment of the froth receiving device 21e may include a retaining member 57 that is attached to a support body 53, as may be understood from FIG. 9. The retaining member 57 may be sized and configured to receive froth over the top edge of the retaining member and funnel that froth into an aperture 24 formed in a portion of the support body 53. Floats 23 may also be attached to the support body 53 to permit the support body and retaining member to float in the slurry. A portion of the support body 53 may also be configured to provide buoyancy.

The support body 53 may include passageways or conduits 59 that permit fresh water to pass through the support body 53 and out of sprayers, spray nozzles 58 or other outlets. The fresh water may be supplied via a conduit 54, which may supply water from a reservoir or other source of water connected to that conduit 54. One or more pumps may be connected to the conduit 54 to help facilitate the transport of water to the conduits 59 of the support body 53.

The spray nozzles 58 are configured to spray the froth received in aperture 24 with water. The water sprayed from the nozzles 58 may facilitate transport through conduit 26 and to help facilitate separation of the solid material within the froth from the liquid. The use of water may help reduce the concentration of air included in the froth being separated by the separation device, which may help improve the capacity of the separation device to separate solids from the liquid of the froth. This may be particularly true when a hydrocyclone is used as the separation device.

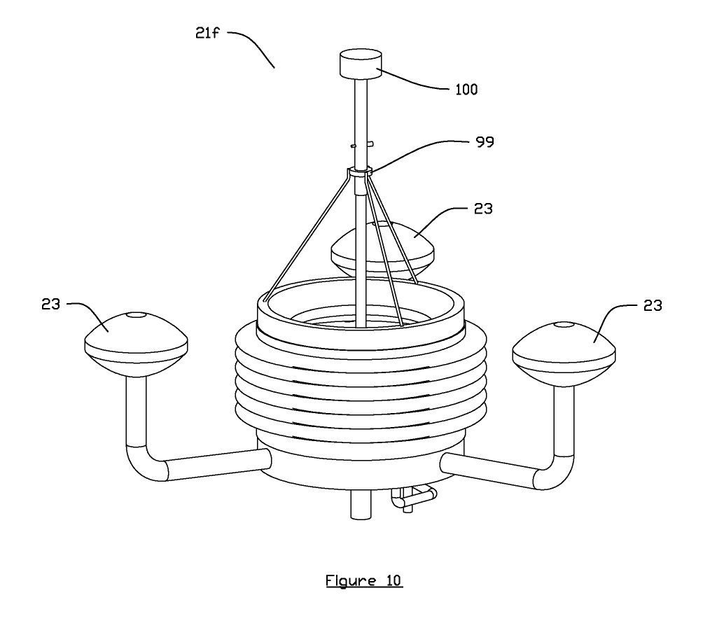

Referring to FIGS. 10, yet another embodiment of the froth receiving apparatus 21f may also be configured to include spray nozzles for spraying received froth with water. The froth receiving device 21f may also include a depth adjustment mechanism 99. The depth adjustment mechanism 99 may include a member that is interconnected to another member via one or more releasable connections, such as a moveable pin. The pin may be moved to an unlocked position to retract or extend an elongated member, such as a tube, and then moved to a locked position to lock the new extended or retracted position of the elongated members. The adjustable elongated member may have a terminal end that is connected to a weighted or non floating portion of the froth receiving body of the froth receiving device 21f so that any adjustment of the elongated member may increase or decrease the depth position of the froth receiving device 21f in the slurry of a flotation cell tank.

Referring to FIG. 10A, the froth receiving device 21g may include a retaining member 157 that is attached to a plurality of floatable bodies or floats 23. The retaining member 157 may be configured so that it is not a buoyant body. The retaining member 157 may include one or more channels 158 formed between adjacent walls of the retaining member 157. The channel 158 may extend from a top portion of the retaining member to a bottom portion that is in communication with a froth collection channel 160. A middle aperture 124 may also be defined by the retaining member 158. A plurality of openings 131 may be formed in the retaining member 157 adjacent to the froth collection channel 160 so that the froth received in the middle aperture 124 may pass directly into the froth collection channel via openings 131. The froth collection channel may be in communication with an opening that connects the froth connection channel 160 to the conduit 26 for transporting the froth to one or more particle separation devices 27.

A conduit 154 for transporting water to the retaining member 157 may include portions that feed water to the nozzles 159. The retaining member 157 may include passageways for receiving water from conduit 154 to feed the water to the nozzles 159. The nozzles 159 may be configured to spray water inside the channel 158 to spray the froth received in the channel 158 with water. That water may also pass into the froth collection channel 160 and be fed to the conduit 26 for being transported to the particle separation device 27.

A depth adjustment mechanism 99 may be connected to the retaining member 157 or other part of the froth receiving device to adjust the depth of the froth receiving device in or on the slurry. For example, the depth may be adjusted from a position that places the froth receiving device on the top of the slurry to a position that places the froth receiving device below a portion of the slurry. The depth adjustment device may include an elongated member 101 that is retracted or extended from a collector 100 positioned above the froth receiving device. A terminal end of the elongated member 101 may be affixed to a weighted or non-buoyant base portion of the retaining member 158 so that adjustment of the elongated member 101 may effect a change in depth of the retaining member 157.

The elongated member may include a plurality of holes 101a. Each hole may be sized to receive a pin for setting a depth or position of the froth receiving device. A pin 103 may be positioned into a particular hole to set the depth position for the froth receiving device. If it is desired to adjust the depth of the froth receiving device, the pin may be moved out of the hole 101a in which it is positioned so that the elongated member may be retracted or extended to adjust a position of the froth receiving device. The pin 103 may then be inserted into a different hole 101a to lock the froth receiving device in its new depth position.

The pin 103 may be part of a depth locking mechanism that is attached to a top portion of the froth receiving device. The depth locking mechanism may be supported by the retaining member 157 or by a support of the froth receiving device. The elongated member 101 may extend from a collector 100 that is supported on a frame adjacent to a ceiling above the froth receiving device. An end of the elongated member may be connected to the froth receiving device such as a portion of the retaining member 157 so that movement of the elongated member helps adjust the depth of the froth receiving device.

Referring to FIG. 17, a froth receiving device 21h may include a circular float 179 that provides buoyancy to the body 181 of the froth receiving device and stability to that device when positioned in the froth formed in a flotation cell. The body 181 defines a retaining member 182 that is wider than an inlet 183 defined in the body 181 to receive froth. The retaining member 182 may provide a wider diameter to help funnel froth into the inlet 183. The inlet 183 may be in communication with a cavity or channel formed in the body 181 that is connected with a conduit for transporting the received froth to another device, such as a particle separation device, launder, or other material processing device. The body 181 may include projections that are spaced apart from each other and attach the body 181 to the float 179. The projections may define openings 185 therebetween.

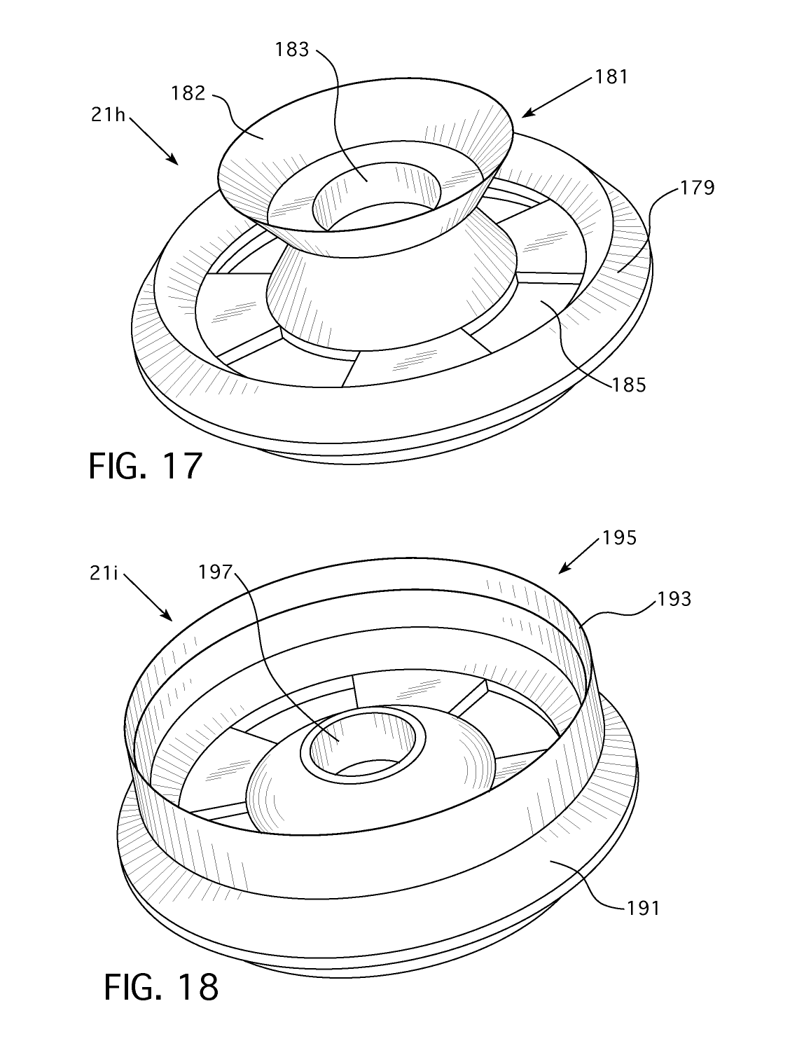

Referring to FIG. 18, yet another froth receiving device 21i is illustrated that has a circular float 191 that is attached to a retaining member 193 and a body 195. An annular member 194 may be attached between the body 197 and the float 191 to define a floor along which froth may be retained after the froth passes over the top edge of the retaining member 193 for collection into the body 195 via mouth 197. Froth may be sucked through the mouth 197 via a vacuum generated by one or more pumps connected to the body 195 via one or more conduits or the froth may be fed into the mouth 197 via gravity.

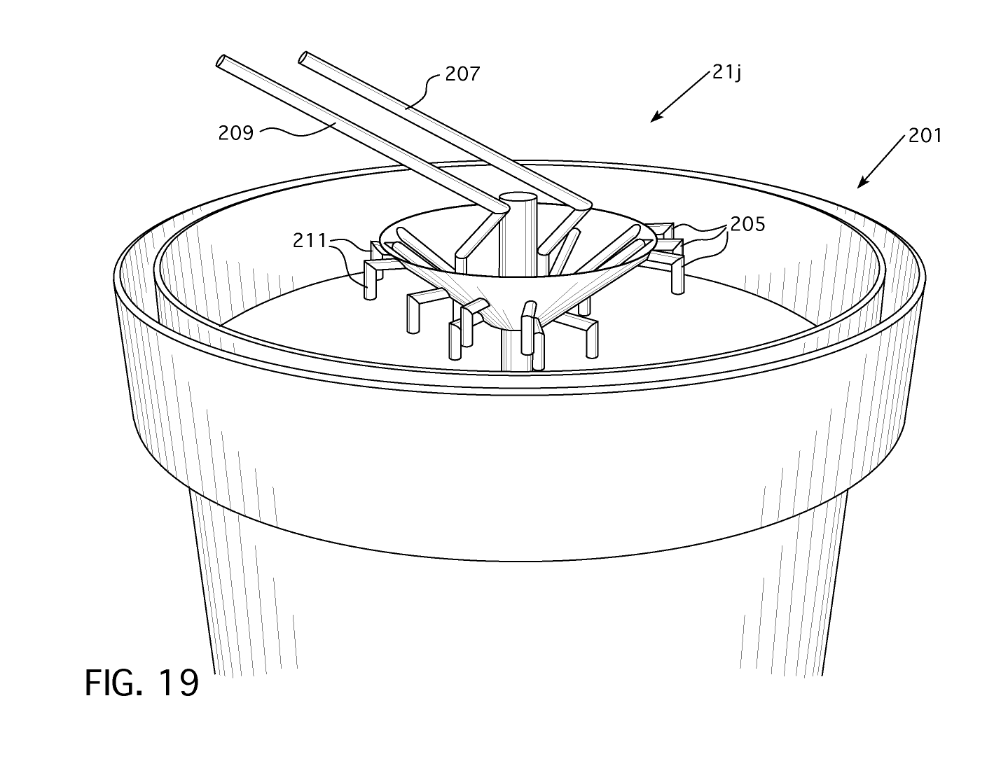

Referring to FIG. 19, a froth receiving device 21j may be attached to a crowder of a flotation cell such that the froth receiving device 21j is positioned adjacent the center of the tank of the cell. Froth may pass over a retaining member 201. A plurality of first froth receiving conduits 205 may be connected to a first main froth extraction conduit 207 in communication with a first pump (not shown) and a plurality of second froth receiving conduits 211 may be connected to a second froth receiving conduit 209 in communication with a second pump (not shown). The first and second froth receiving conduits 207 and 209 may extract froth that passes over the retaining member 201 and is retained therein via a pressure differential created by the pumps to which the froth receiving conduits are attached. The first pump may provide a pressure independent of the second pump so that each froth receiving conduit 207, 209 may operate at a different pressure and provide a different rate of froth recovery. The conduits may also direct froth received therein along different paths to different mechanisms.

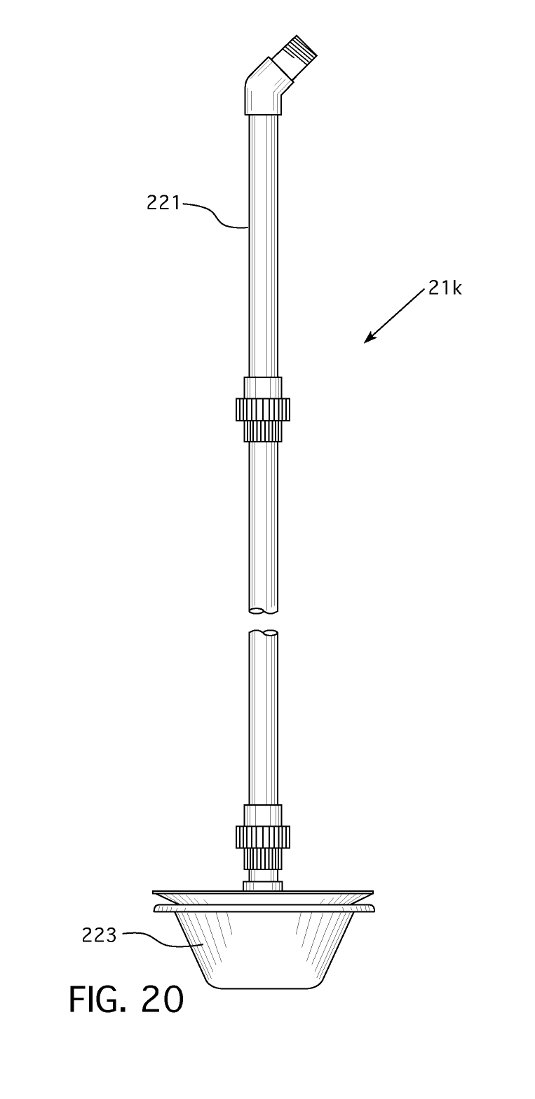

Referring to FIG. 20, a froth receiving device 21k includes a froth extraction conduit 221 in communication with a pump for providing suction used to pull froth therethrough. A suction bowl 223 having a flotation element may be attached thereto. A weir 225 may be positioned or attached on the suction bowl 223 and may extend over the bowl 223 to define an upper wall over which froth must pass to be received into the conduit 221. Froth may pass over the weir 225 and be sucked into the conduit 221 via a spacing provided between a terminal end (not shown) of the conduit 221 and a bottom portion of the bowl 223.

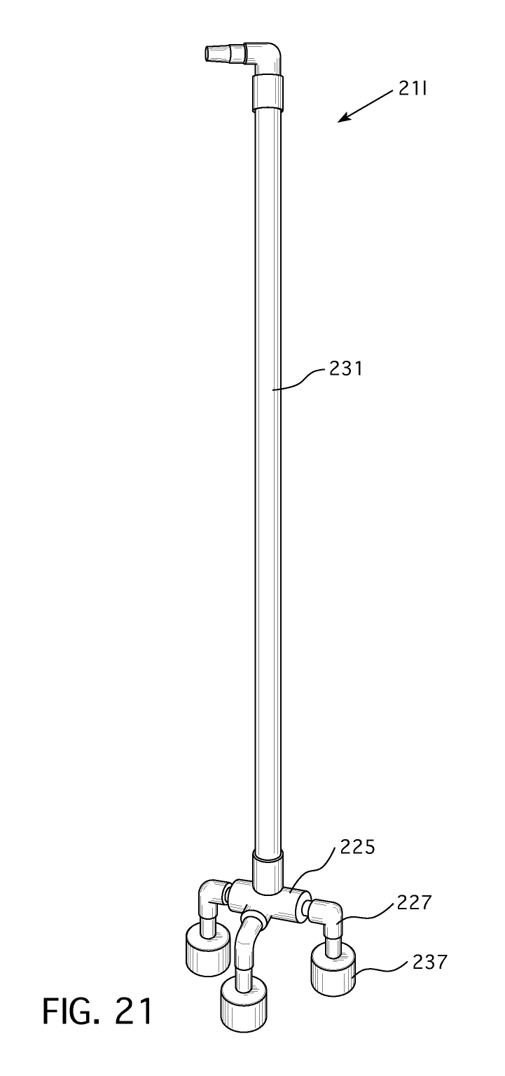

Referring to FIG. 21, another embodiment of the froth receiving device 21l is illustrated in which a conduit 231 is attached to a central froth receiving body 225 that is in communication with multiple inlets 227. The inlets may project from the froth receiving body 225 and have channel that are in communication with a cavity formed in the froth receiving body. The cavity may be in communication with the passageway defined by the conduit 231 through which froth may pass or move. Wide mouth pieces 237 may be attached to the terminal end of each inlet 227 to help funnel froth into the inlets 227.

It should be appreciated that embodiments of the froth receiving devices such as froth receiving device 21l or 21k may be attached to a launder and include piping for passing material or feeding material into the launder or may alternatively include piping for passing material directly to a particle separation device such as a hydrocyclone or cyclone. The froth receiving devices 21l or 21k for example may be hung from, attached to, moveably attached to, or suspended from the launder to position the froth receiving devices at a desired depth in the froth for extracting froth prior to the froth passing into the launder.

It is also contemplated that embodiments of froth receiving devices may include hand holdable devices or devices that are positionable in the froth by a person manually moving a froth receiving body or a tubing or conduit attached thereto. Such an embodiment may include flexible tubing, telescoping piping, telescoping tubing, or other types of flexible conduits or telescoping conduits that may permit manual adjustment of the froth receiving body of such a device that is configured to help receive and move froth collected by the device to another processing element.

It should be appreciated that embodiments of the froth receiving device may be offered for sale as a kit for retrofitting or otherwise installing such devices in pre-existing flotation machines. For instance, a pre-existing flotation machine that was previously installed at a facility may be retrofitted to include one or more froth receiving devices 21. Such an installation may merely include the use of a kit that permits the installation of one or more pumps, one or more particle separation devices, one or more froth receiving devices, and piping or other conduits for interconnecting the froth receiving devices to the particle separation devices and one or more pumps. If the froth receiving devices are configured to be height adjustable, such kits may also include elongated members and collectors, spools, or other actuation mechanism used to move the elongated members to adjust a depth of the froth receiving device in the tank.

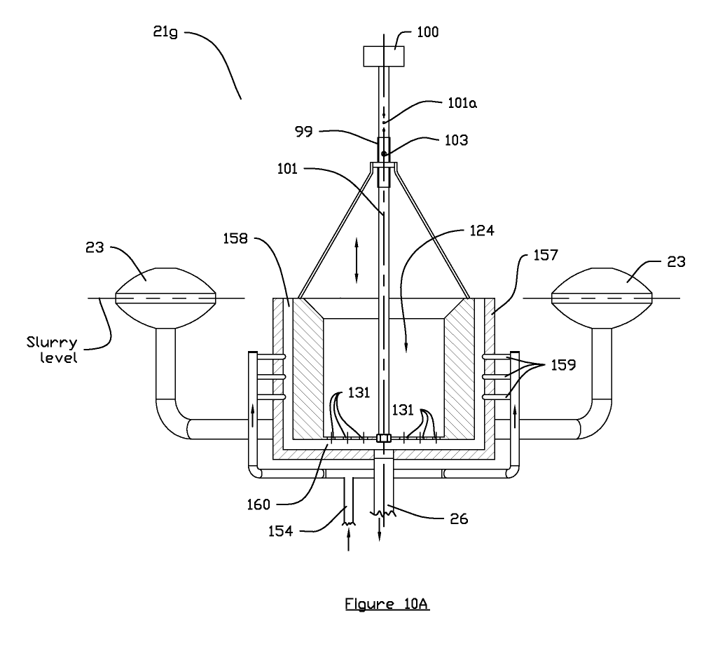

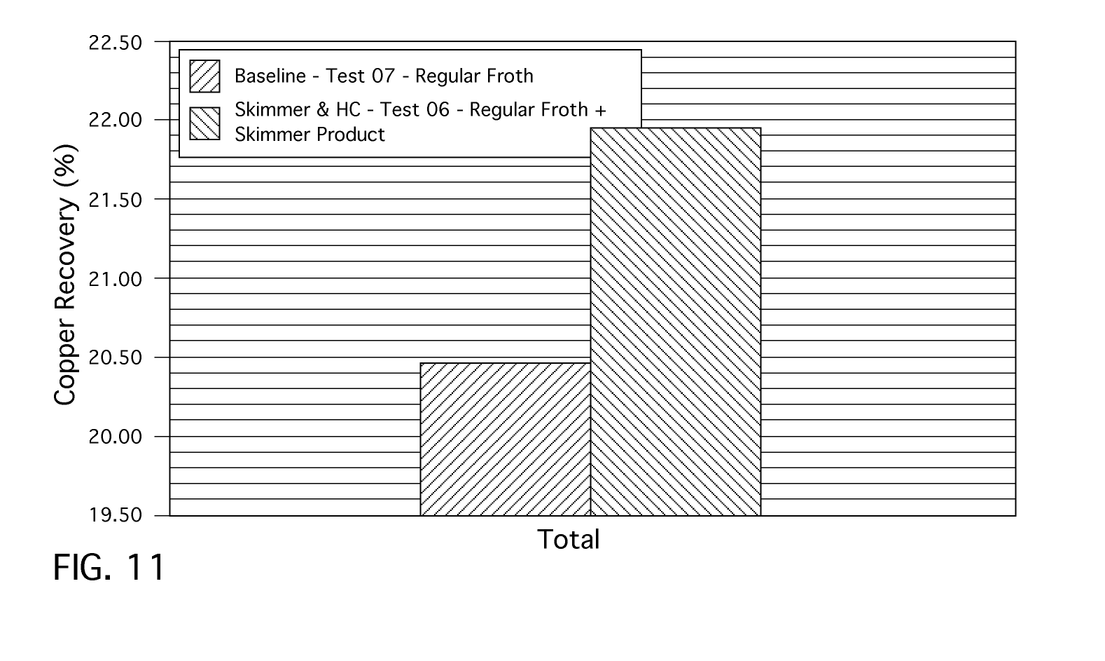

Testing was conducted to determine the impact the use of embodiments of the froth receiving device may have on the recovery of desired materials from a slurry, or pulp, of a floating machine. A first test was conducted to compare how much copper may be recovered using a cell of a flotation machine. In one test, the cell of the flotation machine did not utilize a froth receiving device (which is identified as Base line−Test 07 in FIG. 11). Another test was run where the flotation cell did utilize a froth receiving device that fed froth to a hydrocyclone for separating the particles in the froth from the liquid of the froth (which is identified as Skimmer & HC−Test 06 in FIG. 11). The results of the testing showed that the use of the froth receiving device in the flotation cell improved the percent of the copper collected by about 1.5%, as may be appreciated from the chart of FIG. 11. A 1.5% improvement in copper recovery is a significant increase in copper recovery. For example, such an increase in recovery of flotation machines may have a value of tens of millions of dollars in annual operating profit to an operator of such machines. For instance, copper concentrators typically handle over 100,000 tons per day of solids. Increasing recovery from a 0.5% grade copper ore from 92% to 93.5%, for example, represents a significant savings and improved profitability to the operator of the copper concentrator.

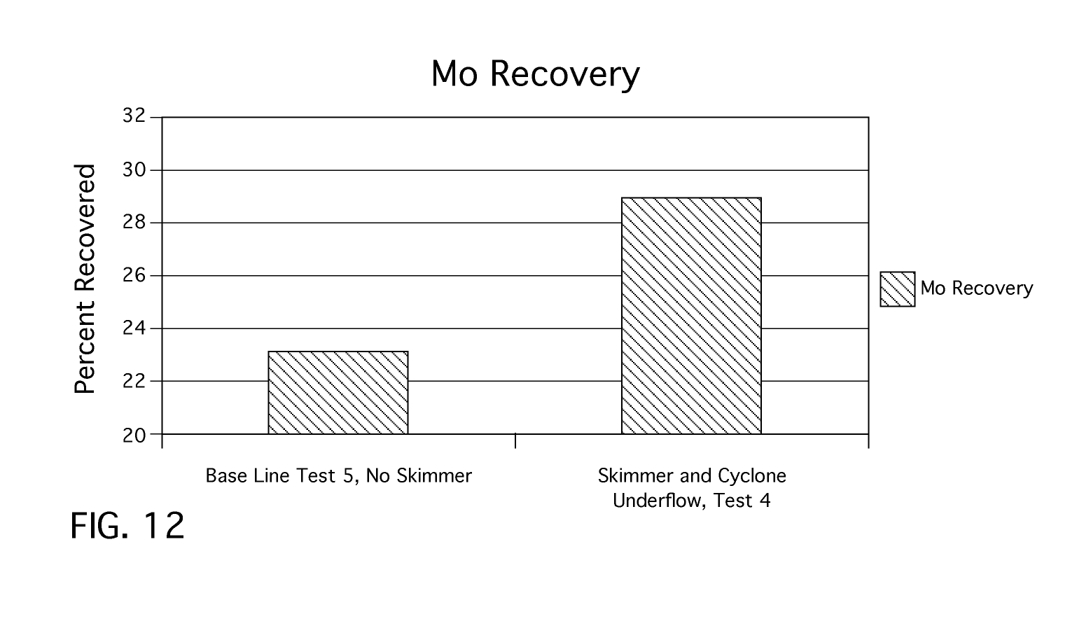

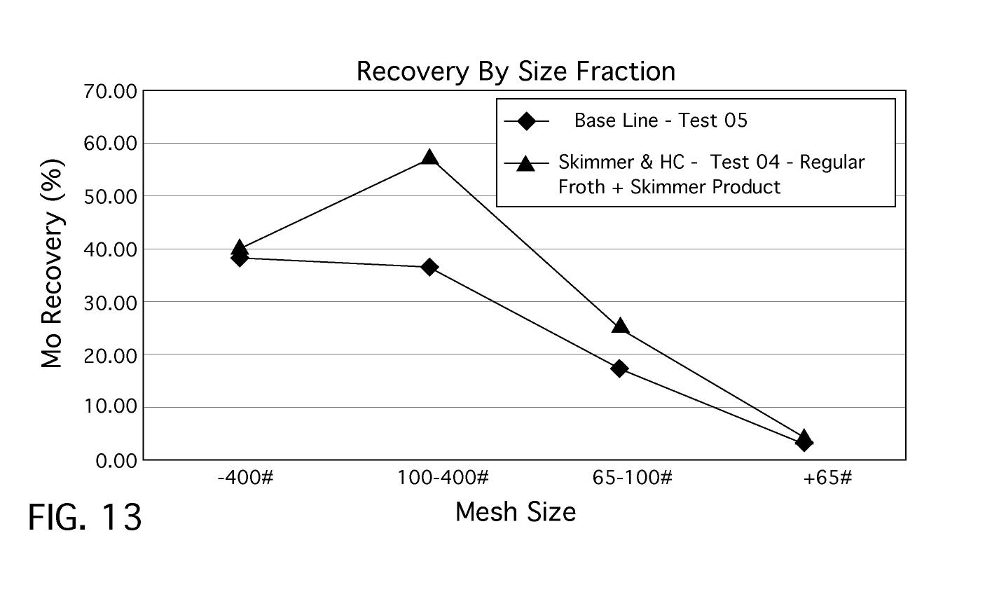

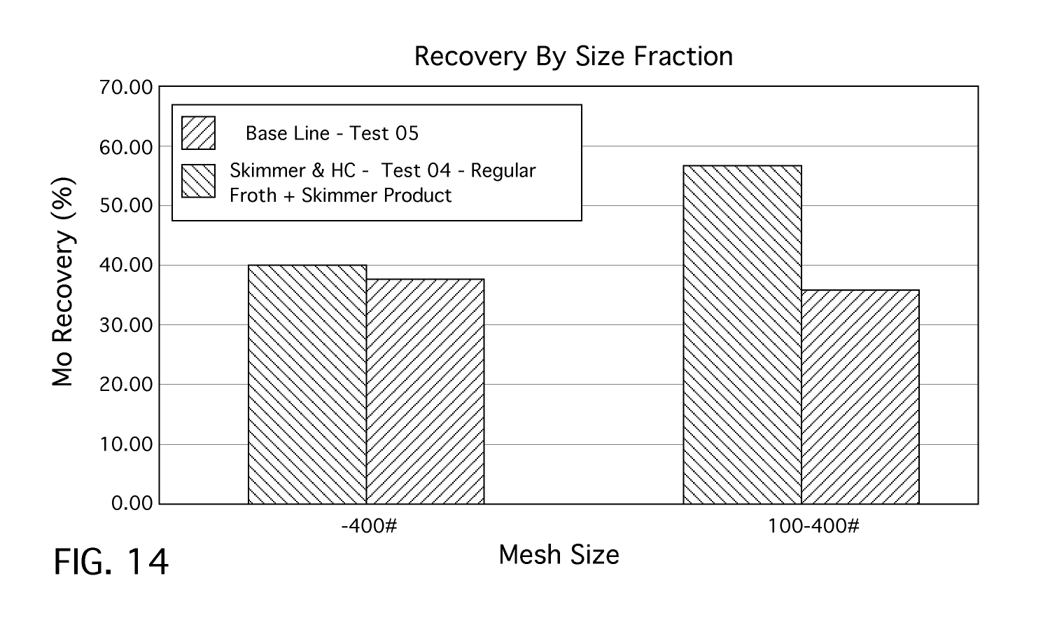

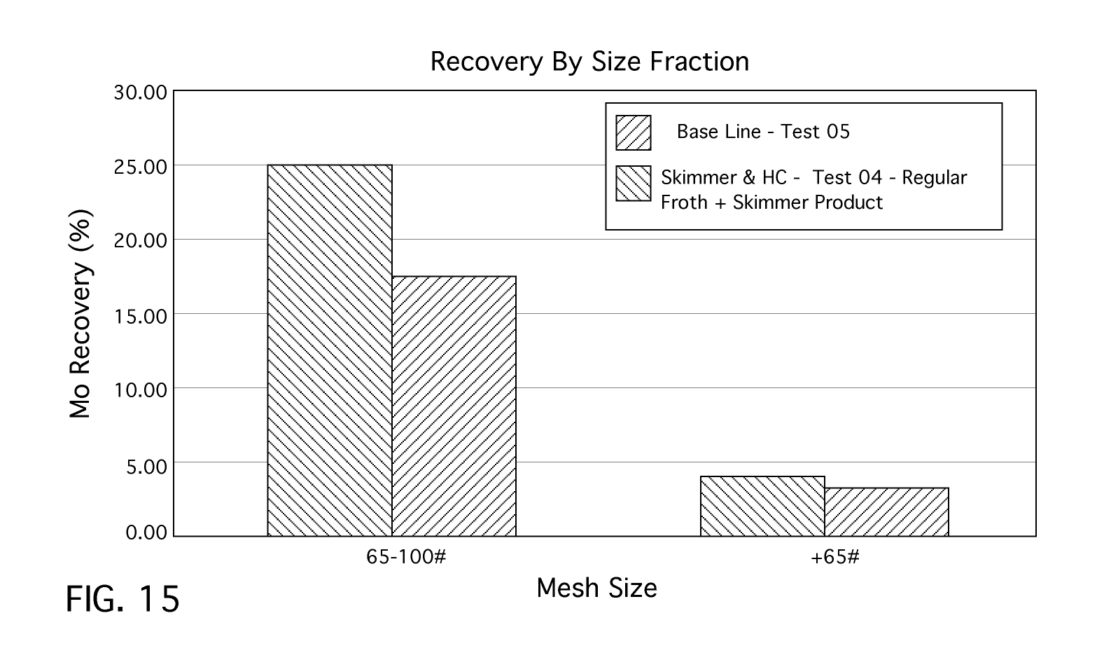

Another test was conducted to evaluate the use of froth receiving devices. The second set of tests compared how much molybdenum may be recovered using a cell of a flotation machine. In one test, the flotation cell did not utilize a froth receiving device (which is identified as Base Line−Test 05−Regular Froth in FIGS. 13-15 and Base Line Test 5, No Skimmer in FIG. 12). In another test, the flotation cell did utilize a froth receiving device that fed froth to a hydrocyclone for separating the particles in the froth from the liquid of the froth (which is identified as Skimmer&HC−Test 04−Regular Froth+Skimmer Product in FIGS. 13-15 and Skimmer and Underflow, Test 4 in FIG. 12). The testing results showed that the use of the froth receiving device could improve recovery of molybdenum by over 5%, as may be appreciated from FIG. 12. As may be understood by FIGS. 13-15, the amount of solid fine particles recovered was greatly increased when a froth receiving device was utilized. For instance, almost 20% more molybdenum was recovered from particles of sizes ranging from 150 micrometers to 37 micrometers in size and over 7% more molybdenum was recovered from coarser solid particles of sizes ranging from 150 to 210 micrometers in size when the flotation cell utilized the froth receiving device.

It should be appreciated that the over 5% increase in recovery measured by the second set of testing, the results of which are illustrated in FIGS. 12-15, is a significant and substantial increase. For example, such an increase in recovery of flotation machines may have a value of over tens of millions of dollars in annual operating to an operator of such machines. This increase in profit would be directly attributable to the use of the froth receiving device.

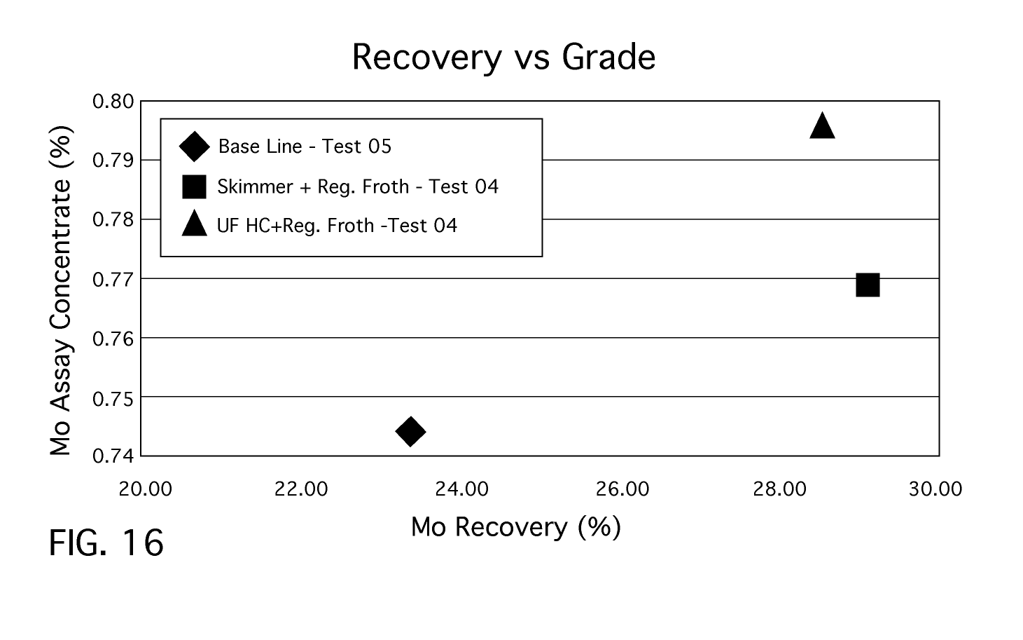

Referring to FIG. 16, the conducted testing also sought to determine what impact the use of a particle separation device may have on the grade of material being recovered. The test results shown in FIG. 16 illustrate results of testing done for the recovery of molybdenum from a flotation cell. FIG. 16, however, shows that not only is the molybdenum recovery appreciably higher, the grade is also better, especially when a particle separation device such as a hydrocyclone is used

The test results shown in FIG. 16 illustrate a comparison of a test run to determine the grade of molybdenum recovered by a flotation cell and the percent of molybdenum recovered by that floatation cell when no froth receiving device or particle separation device was used (identified as Base Line−Test 05 in FIG. 16) with results from tests run when a froth receiving device was used (identified as Skimmer+Reg. Froth−Test 04 in FIG. 16), and when both a froth receiving device and a solid particle separation device was used (identified as UF HC+Reg. Froth−test 04 in FIG. 16). The results of the testing shown in FIG. 16 show that the use of a froth receiving device alone helped substantially increase the amount of molybdenum recovered by the flotation cell. The inclusion of a particle separation device helped to also increase the grade of recovered molybdenum while also providing a significant improvement in overall recovery of molybdenum as compared to the flotation cell operating without the use of either the froth receiving device or a particle separation device.

This increase in recovery of a desired material, such as a metal or mineral, is believed to be due to the fact that the froth receiving device is able to collect relatively coarse particles that are suspended in the froth before those particles may settle out of the froth and fall back down to a lower level of the slurry due to the size and weight of those particles. Because the froth receiving device is able to capture these particles before they settle out of the froth, it is able to improve the amount of particles recovered by the flotation machine and greatly impact the percent of material recovered by the flotation machine.

It is contemplated that some embodiments of the froth receiving device may be utilized in combination with one or more particle separation devices to provide an optimal recovery of a desired solid material from the froth while also providing a higher grade of the material that is recovered in that froth. Other embodiments of the froth receiving device may be utilized so that no particle separation device is utilized to maximize a recovery of a desired solid material. As will be appreciated from those of at least ordinary skill in the art, the considerations utilized for optimizing the use of a particular embodiment of the froth receiving device or froth recovery apparatus is dependent upon a number of factors that include the solid material to be recovered from a slurry, the cost considerations involved, and the increase in grade or recovery that may be provided by a particular particle separation device, if one is utilized for a particular embodiment. Such optimization is well within the work typically done by those of ordinary skill in the art when designing flotation machines and may be determined without any undue experimentation.

It should be understood that numerous changes may be made to the embodiments of the froth receiving device and flotation machine discussed above while still being within the scope of the following claims. For instance, the shape and geometry of the tanks of the flotation cells may be any of a number of different shapes and sizes. As another example, the type of material to be recovered by the cells may be any of a number of different minerals or metals such as, for example, copper, iron, coal, a base metal, a special metal, other minerals or other types of metal. As yet another example, the aeration mechanism used to generate the froth may be any of a number of different alternatives such as aeration mechanisms that utilize self-aspirated technologies or forced air technologies. As yet another example, the specific type of particle separation device utilized to separate particles from the froth may be any of a number of different mechanisms suitable for particle separation from the liquid of the froth. As yet another example and as those of at least ordinary skill in the art will appreciate, the types of reagents, types of depressants/activators, use of different pH levels, use of different collectors, frothers, or modifiers, or use of alternative downstream processes configured to process froth captured at different froth depth levels may be utilized as needed to meet different material recovery objectives, or other design objectives.

While certain present preferred embodiments of the froth receiving device, flotation machines that utilize embodiments of the froth receiving device, and methods of making and using the same have been shown and described above, it is to be distinctly understood that the invention is not limited thereto but may be otherwise variously embodied and practiced within the scope of the following claims.

1. A flotation machine comprising:
at least one flotation cell comprising a tank that is sized to retain a slurry comprised of a liquid mixed with at least one solid material, and a launder configured to receive upper portions of a froth layer that may form on top of the slurry and flow over portions of the tank;
at least one froth receiving device that is sized and configured to be positioned in the tank within said froth layer;
at least one froth receiving device being configured to lower portions of the froth layer which are deeper in the tank than said upper portions of the froth layer received by the launder,
wherein aid lower portions of the froth layer received by the at least one froth receiving device are moveable from the tank at least one pump which is connected to the at least one froth receiving device and which is configured to generate the pressure or suction needed to pull said lower portions of the froth layer into the at least one froth receiving device, and
wherein a depth at which the at least one froth receiving device is positioned in the Tank may be adjusted so as to maintain a relative position of the at least one froth receiving device within the froth layer, even when changes in a pulp level or slurry level within the flotation cell occur.

2. The flotation machine of claim 1 further comprising at least one particle separation device operatively connected to the at least one froth receiving device, wherein the lower portions of the froth layer received by the at least one froth receiving device are moved to the at least one particle separation device.

3. The flotation machine of claim 2 wherein the at least one particle separation device is comprised of at least one cyclone or at least one hydrocyclone.

4. The flotation machine of claim 1 wherein the at least one flotation cell is comprised of a plurality of flotation cells and wherein the at least one froth receiving device is comprised of a plurality of froth receiving devices and wherein each of the at least one froth receiving devices is positioned in a respective one of the tanks of the flotation cells.

5. The flotation machine of claim 1 wherein at least two froth receiving devices are positioned in the tank.

6. The flotation machine of claim 4 further comprising a circuit of particle separation devices, and a plurality of conduits;
each of the conduits being connected between a respective one of the froth receiving devices and the particle separation devices;
the at least one pump being in communication with the conduits to provide pressure for moving lower portions of the froth layers received by the froth receiving devices to the particle separation devices.

7. The flotation machine of claim 1 wherein the flotation machine is a flotation column.

8. The flotation machine of claim 1 further comprising at least one depth adjustment mechanism connected to the at least one froth receiving device such that the at least one froth receiving device is moveable within the froth layer to adjust a position of the at least one froth receiving device within at least one of the froth layer and the slurry below the froth layer.

9. The flotation machine of claim 8 wherein the at least one depth adjustment mechanism is comprised of one of:
a plurality of elongated members connected to a plurality of collectors that move to extend or retract the elongated members to adjust the depth of the at least one froth receiving device, and
a plurality of elongated telescoping members connected to at least one actuation mechanism that is configured to extend and retract the elongated members to adjust the depth of the at least one froth receiving device, and
a plurality of elongated members connected to an actuation mechanism that is configured to wind and unwind the elongated members to adjust the depth of the at least one froth receiving device,
at least one member that is connected to the froth receiving device and is moveable to adjust a position of the froth receiving device, and
a diaphragm within at least one floatable body that is adjustable to adjust the depth of the at least one froth receiving device.

10. A froth recovery apparatus for selectively receiving portions of a froth layer in one of a flotation machine cell and a flotation column cell, independently of a launder configured to receive overflowing upper portions of a froth layer within the flotation machine cell or the flotation column cell, the froth layer being formed on a slurry retained by the flotation machine cell or the flotation column cell, and comprising liquid and solid material, the froth recovery apparatus comprising:
a froth receiving body, the froth receiving body having at least one aperture for receiving lower portions of the froth layer in the flotation machine cell or flotation column cell, the froth receiving body being sized and configured to be positioned in a tank of the one of flotation machine cell and flotation column cell and also being configured to be positioned in the froth layer formed in the tank to receive lower portions of the froth layer which are deeper in the tank than said overflowing upper portions of the froth layer received by the launder; the froth receiving body being further configured to be positioned at a depth in the froth layer or in the slurry below the froth layer; the froth receiving body being further configured to be operatively connected to at least one pump via at least one conduit to generate the pressure or suction needed to pull said lower portions of the froth layer into the froth receiving body; and
at least one conduit connecting the froth receiving body such that lower portions of the froth layer received in the at least one aperture are moveable out of the flotation column cell or flotation machine cell;
wherein a depth at which the froth receiving body is positioned in the tank may be adjusted so as to maintain a relative position of the froth receiving boy within the froth layer, even when changes in a pulp level or slurry level within the flotation machine cell or flotation column cell occur.

11. The froth recovery apparatus of claim 10 wherein the at least one aperture of the froth receiving body is configured to be in communication with at least one of said launder configured to receive overflowing upper portions of a froth layer and a particle separation device via the at least one conduit, such that lower portions of the froth layer received by the at least one aperture of the froth receiving body are moveable to at least one of the launder and the particle separation device.

12. The froth recovery apparatus of claim 10 further comprising a depth adjustment mechanism connected to the froth receiving body such that the froth receiving body is moveable within at least one of the froth layer and the slurry below the froth layer to adjust a position of the froth receiving body within the flotation column cell or flotation machine cell.

13. The froth recovery apparatus of claim 10 wherein the froth receiving body has at least one moveable portion moveable to adjust a position of the at least one aperture.

14. The froth recovery apparatus of claim 10 further comprising at least one pump connected to the at least one conduit to generate the pressure or suction needed to pull said lower portions of the froth layer into the at least one froth receiving device.

15. A method for recovering material from a flotation machine comprising:
creating a froth layer in a tank of a flotation cell having a launder for receiving overflowing upper portions of the froth layer, the tank retaining a slurry, the froth layer being formed adjacent to a top portion of the slurry;
positioning at least one froth receiving device in the tank in addition to said launder, the at least one froth receiving device being configured to be positioned at a differing depths in the froth layer or in the slurry below the froth layer;
receiving lower portions of the froth layer created in the tank which are deeper in the tank than said overflowing upper portions of the froth layer received by the launder; and
moving the lower of the froth layer received by the at least one froth receiving device out of the tank using at least one pump to generate pressure or suction for moving the lower portions of the froth layer received by the at lease one froth receiving device to at least one particle separation device or said launder for receiving overflowing upper portions of the froth layer;
wherein the depth at which the at least one froth receiving device is positioned in the tank may be adjusted so as to maintain a relative position of the froth receiving device within the froth layer, even when changes in a pulp level or slurry level within the flotation cell occur.

16. The method of claim 15 further comprising using at least one particle separation device to separate the at least one solid material from liquid within the moved lower portions of the froth layer and wherein the at least one particle separation device is comprised of at least one cyclone or at least one hydrocyclone.

17. The method of claim 15 comprising:
separating a portion of particulates of at least one solid material within the moved lower portions of the froth layer which are above a predetermined size range from liquid of the moved lower portions of the froth layer;
transporting the liquid of the moved lower portions of the froth layer and a portion of the particulates of the at least one solid material which are under the predetermined size range to a floatation cell;
sending the portion of particulates of the at least one solid material within the moved lower portions of the froth layer which are above the predetermined size range to a device for further material processing.
